(19) United States
(12) Patent Application Publication
(10) Pub. No.: US 2015/0203385 A1
(43) Pub. Date: Jul. 23, 2015

(54) DEWATERING OF THICK FINE TAILINGS WITH GAS INJECTION AND FLOCCULATION

(71) Applicant: SUNCORE ENERGY INC., CALGARY (CA)

(72) Inventors: Adrian Revington, Fort McMurray (CA); Ana Sanchez, Calgary (CA); Trevor Bugg, Fort McMurray (CA); Jamie Eastwood, Fort McMurray (CA)

(21) Appl. No.: 14/408,679

(22) PCT Filed: Jun. 21, 2013
(86) PCT No.: PCT/CA2013/050485

§ 371 Date: Dec. 17, 2014

Related U.S. Application Data
(60) Provisional application No. 61/662,729, filed on Jun. 21, 2012.

(51) Int. Cl. C02F 1/52

(52) U.S. Cl. CPC C02F 1/5227; C02F 1/5272; C02F 1/5281; C02F 2103/10

(57) ABSTRACT

Techniques for injecting gas, such as compressed air, into thick fine tailings can promote water release or flocculant dosage reduction and thereby ameliorate dewatering operations of the thick fine tailings. Gas injection may be done before, during or after addition of a polymer flocculant into the thick fine tailings. Gas injection may be done in an amount, pressure or with gas bubbles so as to reduce the flocculant dosage requirements or increase the water release from released thick fine tailings.

### FIELD OF THE INVENTION

The present invention relates to dewatering of thick fine tailings using gas injection and flocculation.

### BACKGROUND OF THE INVENTION

Oil sands tailings are generated from hydrocarbon extraction process operations that separate the valuable hydrocarbons from oil sands ore. Commercial hydrocarbon extraction processes use variations of the Clark Hot Water Process in which water is added to the oil sands to enable the separation of the valuable hydrocarbon fraction from the oil sand minerals. The process water also acts as a carrier fluid for the mineral fraction. Once the hydrocarbon fraction is recovered, the residual water, unrecovered hydrocarbons and minerals are generally referred to as “tailings”.

Aqueous suspensions and mining tailings may be dewatered through chemical treatments. One chemical treatment method employs flocculation for dewatering. A flocculant may be added to thick fine tailings in order to induce flocculation and the flocculated material may be deposited to allow water release. Some challenges encountered in dewatering operations include the demand for chemical additives to maintain high through-put of the thick fine tailings as well as increasing the rate of dewatering and eventual drying of the thick fine tailings.

### SUMMARY

In some implementations, there is provided a process for dewatering thick fine tailings, comprising:
injecting a gas and adding a flocculant into a flow of thick fine tailings to produce a gas and flocculant treated flow comprising water and flocs; and
releasing the gas and flocculant treated flow at a drying site to allow water to separate and release from the flocs.

In some implementations, the gas is injected in an amount sufficient to increase water released at the drying site.

In some implementations, the gas is injected in an amount sufficient to reduce a quantity of the flocculant for obtaining the gas and flocculant treated flow.

In some implementations, the gas comprises air.

In some implementations, the gas is injected at a pressure between approximately 10 psi and 100 psi. In some implementations, the gas is injected at a pressure between approximately 30 psi and 90 psi. In some implementations, the gas is injected at a pressure below a pressure threshold so as to obtain increased water release compared to no air injection. In some implementations, the gas is injected at a pressure between 25 psi and 55 psi. In some implementations, the gas is injected at a pressure between 30 psi and 50 psi.

In some implementations, the thick fine tailings has a line pressure between approximately 5 psi and 30 psi upon adding the flocculant.

In some implementations, the flocculant is added as an aqueous solution comprising a dissolved flocculating agent.

In some implementations, the flocculant is added into the thick fine tailings before the gas is injected.

In some implementations, the flocculant is added into the thick fine tailings while the gas is being injected.

In some implementations, the flocculant is added into the thick fine tailings after the gas has been injected.

In some implementations, the flocculant comprises a high molecular weight anionic polymer flocculant.

In some implementations, the polymer flocculant is added into the thick fine tailings at a dosage between approximately 500 and 1500 ppm on a clay basis.

In some implementations, the dosage is between approximately 600 and 2200 ppm on a total solids basis.

In some implementations, the process also includes screening the thick fine tailings prior to injecting the gas and adding the flocculant, to remove coarse debris therefrom.

In some implementations, the thick fine tailings comprise oil sands thick fine tailings.

In some implementations, the thick fine tailings are retrieved from a pond as mature fine tailings.

In some implementations, there is provided a system for dewatering thick fine tailings, comprising:
a fluid transportation assembly for providing a thick fine tailings fluid flow;
a gas injection device for injecting a gas into the fluid flow to produce a gas-treated
fluid;
a mixer for mixing a flocculant into the fluid flow; and
a drying site for receiving a gas and flocculant treated mixture comprising water and flocs, the drying site allowing water to separate from the flocs and/or evaporate.

In some implementations, the gas injection device is configured for injecting the gas in an amount sufficient to increase water released at the drying site.

In some implementations, the gas injection device injects the gas in an amount sufficient to reduce a quantity of the flocculant for obtaining the mixture.

In some implementations, the gas injection device is configured for injecting air.

In some implementations, the gas injection device is configured for injecting the gas between approximately 10 psi and 100 psi.

In some implementations, the gas injection device is configured for injecting the gas between approximately 30 psi and 90 psi.

In some implementations, the gas is injected at a pressure below a pressure threshold so as to obtain increased water release compared to no air injection.

In some implementations, the gas is injected at a pressure between 25 psi and 55 psi. In some implementations, the gas is injected at a pressure between 30 psi and 50 psi.

In some implementations, the mixer is configured for mixing the flocculant into the fluid flow before the gas injection device injects the gas.

In some implementations, the mixer is configured for mixing the flocculant into the fluid flow while the gas injection device is injecting the gas.

In some implementations, the mixer is configured for mixing the flocculant into the fluid flow after the gas injection device has injected the gas.

In some implementations, the flocculant comprises a high molecular weight anionic polymer flocculant.

In some implementations, the mixer mixes the polymer flocculant into the gas-treated fluid at a dosage between approximately 500 ppm and 1500 ppm on a clay basis.

In some implementations, the mixer mixes the polymer flocculant into the gas-treated fluid at a dosage between approximately 600 and 2200 ppm on a total solids basis.

In some implementations, the thick fine tailings comprise oil sands thick fine tailings.

In some implementations, the thick fine tailings are retrieved from a pond as mature fine tailings.

In some implementations, there is provided a gas injection device for treating thick fine tailings, comprising:
an inlet for receiving the thick fine tailings;
an outlet for releasing gas-treated tailings; and
a gas injector disposed between the inlet and the outlet, the gas injector configured to inject gas into the thick fine tailings to produce a gas-treated tailings sufficient to facilitate flocculation and dewatering of the thick fine tailings.

In some implementations, the gas injector comprises a transitional housing disposed between the inlet and the outlet, the transitional housing including at least one interface separating the transitional housing between a first chamber where the thick fine tailings entering the inlet is allowed to travel before exiting from the outlet, and a second chamber where the gas therein is pressurized, the at least one interface being configured for allowing the gas from the second chamber to be introduced into the thick fine tailings in the first chamber.

In some implementations, the transitional housing comprises an inlet having a substantially circular cross-section, and a main section having a substantially rectangular cross-section.

In some implementations, the transitional housing comprises an outlet having a substantially circular cross-section.

In some implementations, the transitional housing includes top and bottom plates, and a pair of opposite side plates, so as to provide the transitional housing with at least one substantially rectangular cross-section.

In some implementations, the transitional housing comprises a side nozzle plate, provided with a nozzle for receiving the gas from a source of pressurized gas.

In some implementations, the nozzle is provided on a side nozzle cover being removably mountable onto a corresponding opening of the side nozzle plate.

In some implementations, the device also includes a nozzle plate gasket removably mountable between a rim of the opening of the side nozzle plate and the side nozzle cover in order to provide a seal.

In some implementations, the transitional housing comprises an interface plate configured for receiving the at least one interface.

In some implementations, the device also includes a diffuser frame removably mountable onto the interface plate of the transitional housing for receiving the least one interface.

In some implementations, the device also includes a diffuser cover removably mountable onto the diffuser frame for securing the at least one interface onto said diffuser frame.

In some implementations, the device also includes an interface gasket removably mountable between the interface plate and the diffuser frame in order to provide a seal.

In some implementations, the transitional housing comprises an access opening, and wherein the device comprises a housing cover removably mountable onto the transitional housing for covering said access opening.

In some implementations, the device also includes a housing gasket removably mountable between a rim of the access opening of the transitional housing and the housing cover in order to provide a seal.

In some implementations, the transitional housing further comprises a face plate about which is positioned the inlet.

In some implementations, the transitional housing further comprises a pair of front corner plates, each front corner plate, extending between the face plate and a corresponding side plate.

In some implementations, the transitional housing comprises front and rear support plates extending within the second chamber for supporting the at least one interface.

In some implementations, the transitional housing comprises a front top ramp extending from a bottom portion of the inlet to an upper portion of the front support plate, and further comprises a rear top ramp extending from an upper portion of the rear support plate to a bottom portion of the outlet.

In some implementations, the transitional housing further comprises an end plate about which is positioned the outlet.

In some implementations, the transitional housing further comprises a pair of rear corner plates, each rear corner plate extending between the end plate and a corresponding side plate.

In some implementations, the housing cover is removably securable against a top plate of the transitional housing by means of lifting lugs.

In some implementations, the lifting lugs are mountable onto corner plates of the transitional housing.

In some implementations, the at least one interface comprises at least one diffuser plate.

In some implementations, the at least one diffuser plate is composed of ceramic.

In some implementations, the least one interface comprises a plurality of the ceramic diffuser plates, and wherein plates, frames and gaskets of the device are configured in accordance with the ceramic diffuser plates.

In some implementations, the plurality of ceramic diffuser plates comprises four ceramic diffuser plates.

In some implementations, the inlet or the outlet is in fluid communication with a mixer for mixing a flocculant into the thick fine tailings.

In some implementations, the inlet is in fluid communication with the mixer.

In some implementations, the gas injector is configured in sufficient proximity with a mixer for mixing a flocculant into the thick fine tailings such that the gas and the flocculant are simultaneously injected into the thick fine tailings.

In some implementations, the flocculant comprises a high molecular weight anionic polymer flocculant.

In some implementations, the transitional housing has cross-sections of different configurations between the inlet and the outlet.

In some implementations, the gas injector is peripherally mounted about a flow of the thick fine tailings so as to introduce the gas therein.

In some implementations, the inlet receives the thick fine tailings via a cylindrical inlet pipe, and the outlet releases the gas-treated thick fine tailings via a cylindrical outlet pipe.

In some implementations, the gas injector is annular and mounted substantially co-axially with the cylindrical inlet pipe and the cylindrical outlet pipe so as to introduce the gas into the flow of the thick fine tailings along a plurality of radial trajectories.

In some implementations, the gas injector comprises a circular flange. In some implementations, the circular flange comprises a rim defining a circular passage having an internal diameter allowing the flow of the thick fine tailings to pass therethrough. In some implementations, the circular flange further comprises: a distribution chamber configured circumferentially within the rim for receiving the gas to be introduced into the thick fine tailings; and orifices positioned circumferentially around the rim and being in fluid communication with the distribution chamber for receiving the gas and introducing the gas into the flow of the thick fine tailings. In some implementations, the orifices are configured so as to be inwardly facing and arranged at regular interval locations around the rim, so as to inject the gas toward a center of the flow of the thick fine tailings. In some implementations, each interval location includes at least two of the orifices that are oriented so as to tapper inwardly toward each other as the at least two orifices extend from the distribution chamber toward the flow of the thick fine tailings.

In some implementations, the thick fine tailings comprise oil sands thick fine tailings.

In some implementations, the gas injector includes gas injection orifices sized below about 1.5 millimeters. In some implementations, the gas injection orifices are sized between about 1 millimeter and about 1.5 millimeters.

In some implementations, there is provided a method of reducing flocculant dosage for flocculating thick fine tailings comprising injecting an effective amount of gas into the thick fine tailings.

In some implementations, injecting the gas is performed before, after or during flocculation of the thick fine tailings.

In some implementations, the thick fine tailings comprise oil sands thick fine tailings.

In some implementations, the injecting of the gas and the flocculant dosage are further provided so as to increase water release from flocculated thick fine tailings compared to no gas injection.

In some implementations, the injecting of the gas is performed at a gas pressure between 30 psi and 90 psi.

In some implementations, there is provided a method of increasing water release from flocculated thick fine tailings obtained by flocculant addition to thick fine tailings, comprising injecting an effective amount of gas into the thick fine tailings and/or the flocculated thick fine tailings.

In some implementations, injecting the gas is performed before, after or during flocculation of the thick fine tailings.

In some implementations, the thick fine tailings comprise oil sands thick fine tailings.

In some implementations, the gas is injected below a gas pressure threshold of about 55 psi.

In some implementations, the gas is injected with a gas pressure between about 25 psi and about 55 psi.

In some implementations, the gas is injected with an air pressure between about 30 psi and about 50 psi.

It should also be noted that various implementations and features described above may be combined with other implementations and features described above and herein.

### BRIEF DESCRIPTION OF THE DRAWINGS

FIG. 1 is a top perspective view of an injection device.

FIG. 2 is an exploded view of what is shown in FIG. 1.

FIG. 3 is an exploded view of some of the components shown in FIG. 2.

FIG. 4 is a plan view of a support plate.

FIG. 5 is a plan view of a ramp.

FIG. 6 is a plan view of a bottom plate.

FIG. 7 is a plan view of an interface plate.

FIG. 8 is a plan view of an interface gasket.

FIG. 9 is a top perspective view of a diffuser frame.

FIG. 10 is a top plan view of what is shown in FIG. 9.

FIG. 11 is a side elevational view of what is shown in FIG. 10.

FIG. 12 is a partial enlarged perspective view of a portion of what is shown in FIG. 9.

FIG. 13 is a cross-sectional view taken along line XIII-XIII of FIG. 10.

FIG. 14 is a top perspective view of a porous ceramic diffuser plate.

FIG. 15 is a top plan view of what is shown in FIG. 14.

FIG. 16 is a side elevational view of what is shown in FIG. 15.

FIG. 17 is a cross-sectional view of a diffuser frame being provided with a diffuser plate separating a first chamber from a second chamber.

FIG. 18 is a top perspective view of a diffuser cover.

FIG. 19 is a top plan view of what is shown in FIG. 18.

FIG. 20 is a plan view of a face or an end plate.

FIG. 21 is a plan view of a corner plate.

FIG. 22 is a perspective view of a side nozzle plate.

FIG. 23 is a top plan view of what is shown in FIG. 22.

FIG. 24 is a plan view of a side plate.

FIG. 25 is a plan view of a top plate.

FIG. 26 is a partial cross-sectional view of a portion of the top plate shown in FIG. 25.

FIG. 27 is a plan view of a nozzle plate gasket.

FIG. 28 is a perspective view of a side nozzle cover provided with a nozzle.

FIG. 29 is a top plan view of what is shown in FIG. 28.

FIG. 30 is a plan view of a housing gasket.

FIG. 31 is a plan view of a housing cover.

FIG. 32 is a perspective view of a lifting lug.

FIG. 33 is a front view of what is shown in FIG. 32.

FIG. 34 is a side elevational view of what is shown in FIG. 32.

FIG. 35 is a plan view of an upper portion of the lifting lug shown in FIG. 32.

FIG. 36 is a perspective view of a pipe and flange combination to be used with an inlet of the injection device.

FIG. 37 is a side elevational view of what is shown in FIG. 36.

FIG. 38 is a front view of what is shown in FIG. 36.

FIG. 39 is a graphical representation of results obtained from an experiment involving a gas injection device and a polymer dosage.

FIG. 40 is another graphical representation of different results obtained from the experiment of FIG. 39.

FIG. 41 is yet another graphical representation of different results obtained from the experiment of FIG. 39.

FIG. 42 is yet another graphical representation of different results obtained from the experiment of FIG. 39.

FIG. 43 is a graphical representation of combined results obtained from various experiments.

FIG. 44 is side elevational view of another gas injection device.

FIG. 45 is cross-sectional view of the injection device of FIG. 44, taken along the line XLIV-XLIV.

FIG. 46 is a block flow diagram.

FIG. 47 is a schematic of a pipeline layout showing polymer and air injection points.

### DETAILED DESCRIPTION

Various techniques are described for dewatering thick fine tailings using the addition of a chemical, such as a flocculant, as well as gas injection. The techniques are for thick fine tailings and may also be employed for other aqueous suspensions that include fine solid particles, in order to promote dewatering prior to storage and drying in a drying site for subsequent removal, use or simply leaving the dewatered material in place.

“Thick fine tailings” are suspensions derived from a mining operation, such as mining extraction, and mainly include water and fines. The fines are small solid particulates having various sizes up to about 44 microns. The thick fine tailings have a solids content with a fines portion sufficiently high such that the fines tend to remain in suspension in the water and the material has slow consolidation rates. The thick fine tailings has a fines content sufficiently high such that flocculation of the fines and conditioning of the flocculated material can achieve a two phase material where water can flow through and away from the flocs. For example, thick fine tailings may have a solids content between 10 wt % and 45 wt %, and a fines content of at least 50 wt % on a total solids basis, giving the material a relatively low sand or coarse solids content. The thick fine tailings may be retrieved from a tailings pond, for example, and may include what is commonly referred to as “mature fine tailings” (MFT).

“MFT” refers to a tailings fluid that typically forms as a layer in a tailings pond and contains water and an elevated content of fine solids that display relatively slow settling rates. For example, when whole tailings (which include coarse solid material, fine solids, and water) or thin fine tailings (which include a relatively low content of fine solids and a high water content) are supplied to a tailings pond, the tailings separate by gravity into different layers over time. The bottom layer is predominantly coarse material, such as sand, and the top layer is predominantly water. The middle layer is relatively sand depleted, but still has a fair amount of fine solids suspended in the aqueous phase. This middle layer is often referred to as MFT. MFT can be formed from various different types of mine tailings that are derived from the processing of different types of mined ore. While the formation of MFT typically takes a fair amount of time (e.g., between 1 and 3 years under gravity settling conditions in the pond) when derived from certain whole tailings supplied form an extraction operation, it should be noted that MFT and MFT-like materials may be formed more rapidly depending on the composition and post-extraction processing of the tailings, which may include thickening or other separation steps that may remove a certain amount of coarse solids and/or water prior to supplying the processed tailings to the tailings pond.

In according with some implementations, the injection of gas may enables reduction of flocculant dosage for flocculating thick fine tailings to be dewatered. “Reducing flocculant dosage” means reducing the dosage of flocculant compared to when gas injection is not performed under similar operating conditions. The flocculant dosage may be considered on a clay basis or on a solids basis in the context of reducing the dosage by injecting gas. In addition, the injection of gas may enable increasing water release from flocculated thick fine tailings obtained by flocculant addition to thick fine tailings. “Increasing water release” means increasing the amount of water released compared to compared to when gas injection is not performed under similar operating conditions.

In the following description, the same numerical references refer to similar elements. The implementations, geometrical configurations, materials mentioned and/or dimensions shown in the figures are exemplary implementations, given for the purposes of description only.

In addition, although some implementations as illustrated in the accompanying drawings include various components and although some implementations of the systems, injection devices and techniques as explained and illustrated herein include geometrical configurations, not all of these components and geometries are essential and thus should not be taken in their restrictive sense, i.e. should not be taken as to limit the scope of the claims. It is to be understood that other suitable components and cooperations therein-between, as well as other suitable geometrical configurations may be used for the systems, injection devices and techniques and corresponding parts described herein, as well as a corresponding conversion kit or set, and/or resulting pipeline or fitting, as briefly explained herein, or as can be easily inferred herefrom.

The following is a list of numerical references for some of the corresponding components illustrated in the accompanying drawings:
1. injection device
3/3a. (bubbles of) gas/air
5. fluid flow
7. inlet
9. outlet
11. transitional housing
11a. first chamber
11b. second chamber
13. interface
14. main section
15. top plate
17. bottom plate
19. (first) side plate
21. (second) side plate (i.e. side nozzle plate)
23. nozzle
25. side nozzle cover
27. opening (of side plate 21)
29. nozzle plate gasket
31. interface plate
33. diffuser frame
35. diffuser cover
37. interface gasket
39. housing cover
41. housing gasket
43. face plate
45. (first) front corner plate
47. (second) front corner plate
49. front top ramp
51. front support plate
53. end plate
55. (first) rear corner plate
57. (second) rear corner plate
59. rear top ramp
61. rear support plate
63. lifting lug
65. diffuser plate (e.g., porous ceramic diffuser plate)
67. access opening (e.g., of top plate 15)
69. pipe and flange connection
71. flange
73. rim
73d. Inner diameter (e.g., of rim 73)
75. circular passage
77. distribution chamber
77d. distribution diameter (e.g., of distribution chamber 77)
79. orifice
81. polymer dosage
83. dosage mechanism

The dewatering techniques including gas injection described herein may be used in an overall operation for treating thick fine tailings. In some implementations, the thick fine tailings are derived from an oil sands mining operation and are oil sands mature fine tailings (MFT) stored in a tailings pond. For illustrative purposes, the techniques described below may be described in reference to this example type of thick fine tailings, i.e., MFT, however, it should be understood that the techniques described can be used for thick fine tailings derived from sources other than an oil sands mining operation.

Upstream of the gas injection, this operation may include retrieving thick fine tailings from a tailings pond; pre-treating the thick fine tailings by screening and/or other treatments. Downstream of the gas injection, this operation may involve releasing the treated tailings at a drying site and allowing water to flow away. The released material may be allowed to dry via drainage, evaporation and other mechanisms and permitted to form dried material that can be reclaimed, relocated, collected or disposed of as needed.

In one implementation of drying of the released material, the dewatering techniques using gas injection produce a two-phase mixture of treated tailings consisting of flocs and released water (i.e. water that released from the tailings during the application of the dewatering techniques). The treated tailings are released via a pipe into a drying site where the water flows away from the flocs and can be collected. The treated tailings can be released into the drying site in thin lifts which facilitates the separation of the water from the flocs. The drying site can be a “beach” or other planar site, and can be inclined or sloped, further facilitating the separation of the water from the flocs. The flocs can then be dried by processes such as evaporation, and then collected or processed once sufficiently dry.

The techniques described herein relate to gas injection in a thick fine tailings flocculation process. More particularly, the techniques may include treating the thick fine tailings with a chemical such as a flocculant to produce treated tailings, injecting gas before during or after the chemical addition so as to produce gas injected treated fine tailings and allowing the gas injected treated fine tailings to dewater.

### Implementations for Dewatering Thick Fine Tailings

In some implementations, there is provided a process and system for dewatering thick fine tailings.

The process may include the following steps: retrieving thick fine tailings from a tailings pond; optionally screening the thick fine tailings by passing it through a screen configured to allow material with a predetermined size to flow there-through and separate coarse debris; injecting gas into the screened thick fine tailings fluid to produce a gas-treated tailings fluid; mixing a chemical such as a flocculant into the gas-treated tailings fluid to produce a mixture; releasing the mixture into a drying site; and allowing water to separate from the released mixture. The mixture released is a two-phase mixture that includes flocs and water. References to “dewatering” herein used in the context of dewatering material released at a drying site, are references to allowing free water to run off from the flocs.

The step of retrieving the thick fine tailings may include dredging. The process may further include adjusting or controlling flow rates of the thick fine tailings. A fluid transportation assembly may then be used to provide a thick fine tailings fluid flow. It should also be understood that the thick fine tailings may be supplied from a source other than a tailings pond, provided that the thick fine tailings are sufficiently matured. For example, the thick fine tailings may come directly from an extraction facility or other tailings source.

The screening step may include providing a thick fine tailings fluid flow from an upstream section toward a downstream section of a screening device. The thick fine tailings fluid flow may be provided in a generally parallel direction with a surface of the screening device. The screening device may be downwardly inclined in the direction of the downstream section. The process may include rejecting the coarse debris from a downstream edge of the screening device. The process may include discharging a stream of the screened fluid from a bottom portion of a collector body through a discharge line. The process may include releasing part of the screened fluid from a top portion of the collector body through an overflow line. The process may include locating the screening device proximate to a perimeter of the tailings pond.

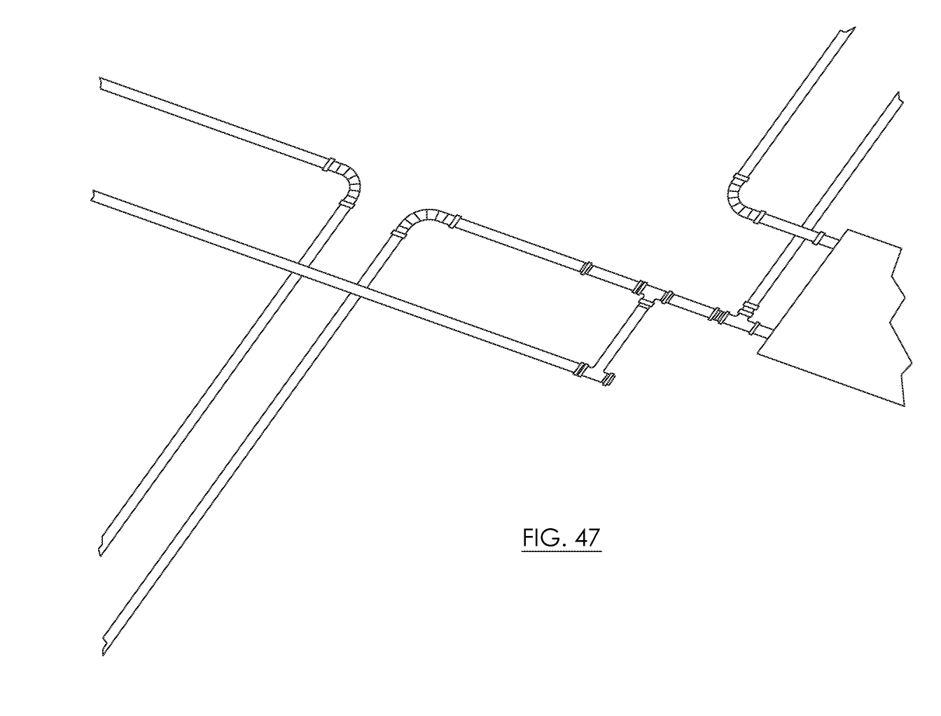

The gas injection step may include injecting air or another gas into the thick fine tailings, which may or may not have undergone screening or other pre-treatments. The gas injection may be done by using a gas injection device to produce the gas-treated thick fine tailings. The gas-treatment of the thick fine tailings may be performed to facilitate flocculation of the thick fine tailings by enhancing dispersion of the flocculant, such as a polymer flocculant. The gas may be injected at or near the point at which the flocculant is added to the thick fine tailings. FIG. 47 shows one possible implementation of such a configuration. In this exemplary configuration, air is injected via a valve after the polymer flocculant is injected. Gas may be injected before the flocculant is added, while the flocculant is added, as well as just after the flocculant has been added. The process may include injecting gas in an amount and having gas bubbles sufficient to increase the water separated from the released material. It may also include injecting gas in an amount and having gas bubbles sufficient to reduce a dosage of the flocculant being added for obtaining the mixture for release and dewatering. The step of injecting gas may also include injecting air over a given pressure range, such as air being pressurized between 10 and 100 psi, or further optionally, between 30 and 90 psi.

As mentioned above, in some implementations air may be selected as the gas for injection. It should be noted however that various gases or mixtures of gases may also be used. For example, the gas may be selected so as to be substantially non-reactive with the thick fine tailings or may display some degree of reactivity with certain components of the thick fine tailings. In some implementations, the gas may include or be an acid gas, such as CO₂, or a basic gas, and such reactive gases may have a coagulating effect on certain compositions of thick fine tailings. For gases that induce a certain level of coagulation, the gas may be injected at a location and at an injection rate so that the coagulation does not significantly hinder the mixing or flocculation. Reactive gases may be used to pre-treat the thick fine tailings prior to flocculant injection or at a certain point after flocculant injection.

The mixing step may include using a mixer to mix the flocculant into the thick fine tailings so as to produce the mixture. In some implementations, the dosage of polymer flocculant mixed into the thick fine tailings to form the flocculant and gas treated tailings may vary. The dosage may be between 600 ppm and 2200 ppm on a total solids basis, or between 1000 ppm and 1800 ppm on a total solids basis, for example. It should also be noted that the flocculant dosing may be done on a clay basis. Clay-based dosing may be preferred, particularly for MFT feeds with variable clay and/or variable total solids content. The flocculant dosing may also be influenced by certain pre-treatments such as shear-thinning, which can reduce the flucculant dosing requirements significantly. In some implementations, the flocculant dosage may be between 500 ppm and about 1500 ppm on a clay basis, for example. More regarding polymer flocculant dosing will be described further below.

The releasing step may include providing a drying site for receiving the mixture and for allowing the mixture to dewater so as to produce dried material.

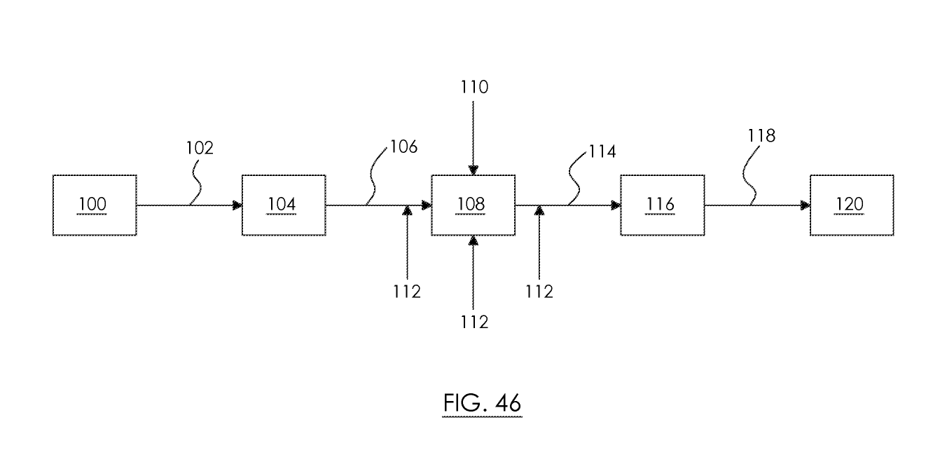

Referring to FIG. 46, showing an example block diagram of a thick fine tailings dewatering operation, there may be a tailings source (100) such as a tailings pond from which the thick fine tailings (102) is retrieved and transported by pipeline. There may be a pre-treatment facility (104) such as a pre-screening facility to produce a pre-treated thick fine tailings (106) which is again transported by pipeline to the next unit operation. The thick fine tailings (106) may then undergo a flocculant addition and mixing step (108) in which a flocculant (110) is added and mixed into the thick fine tailings (106). At the point of flocculant (110) addition, the pressures in the thick fine tailings pipeline may be between 5 and about 30 psi, although other ranges are possible depending on the length of pipeline, the rate at which the thick fine tailings are transported, and any blockages in the line, to name but a few factors. The flocculant may be added in the form of an aqueous solution. The flocculant addition and mixing step may be performed in-line. A gas (112) may be injected into the thick fine tailings before, during and/or after the flocculant addition and mixing, to produce a flocculant and gas treated tailings mixture (114). The treated tailings mixture (114) is then subjected to a conditioning step (116) which may be pipeline conditioning to develop the flocs and promote water release from the mixture. The conditioned mixture (118) may then be provided to a dewatering step (120) that may be performed by releasing the mixture onto a drying area.

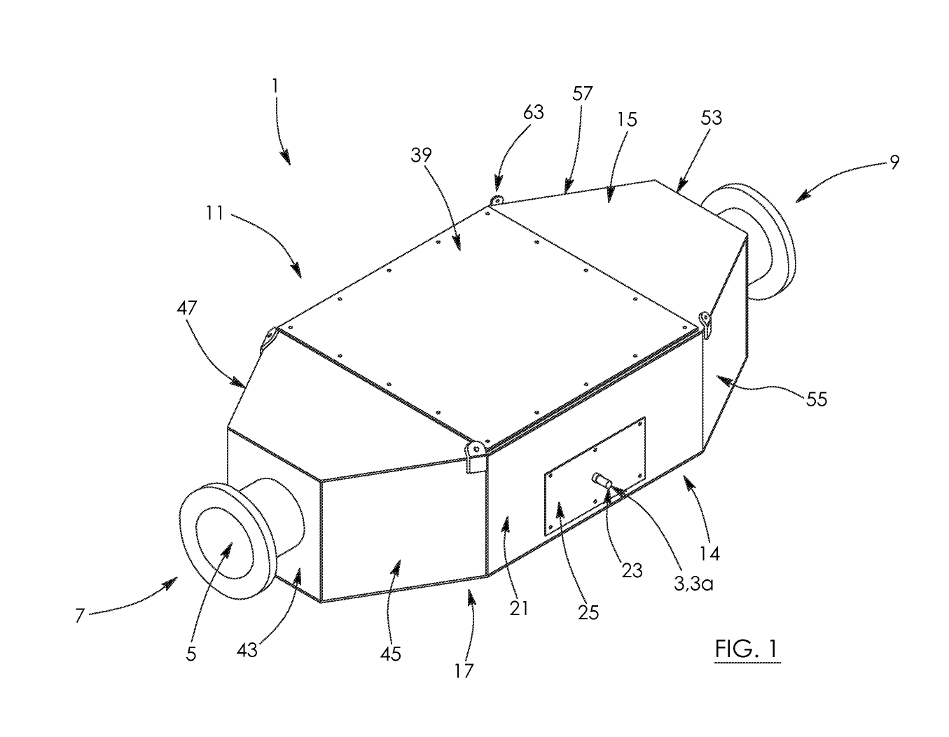

Referring now to FIG. 1, the method may include providing a fluid flow (5) of thick fine tailings, such as oil sands mature fine tailings (MFT). A gas injector (11, 1a) as described below is also provided between an inlet (7) where the fluid flow (5) enters and an outlet (9) where the fluid flow (5) is released. The gas injector (11,1a) injects gas (3) into the fluid flow (5) so as to promote water release among the thick fine tailings. The gas (3) being injected may be air (3a), and it may be injected either before, during, or just after adding a chemical (i.e. a flocculant) to the fluid flow (5) in order to promote water release or reduce chemical dosages before release.

In some implementations, the method may include adding fine bubbles of gas (3) into the fluid flow (5) of thick fine tailings before release, in order to promote water release from the thick fine tailings, including the steps of: a) providing a fluid flow (5) of thick fine tailings to be treated (e.g. via a pipeline carrying thick fine tailings); b) connecting a transitional housing (11) in-line with the fluid flow (5), the transitional housing (11) having an inlet (7) for receiving the fluid flow (5) and an outlet (9) for releasing the fluid flow (5); and c) providing at least one interface (13) within the transitional housing (11) so as to separate the same between a first chamber (11a) or channel where fluid flow (5) entering the inlet (7) is allowed to travel before exiting from the outlet (9), and a second chamber (11b) or channel where gas (3) therein is pressurized or compressed, the at least one interface (13) being configured for allowing fine bubbles of gas (3) from the second chamber (11b) or channel to be introduced into the fluid flow (5) of the first chamber (11a) or channel in order to promote water release of the thick fine tailings coming out of the transitional housing (11).

In another implementation, a method is provided for dewatering thick fine tailings. The method includes contacting the thick fine tailings with a chemical such as a polymer flocculant to produce flocculated tailings. Gas may then be injected into the flocculated tailings to produce gas-treated flocculated tailings. Then, the gas-treated flocculated tailings may be released into a drying site so as to produce a released material. The released material may then be allowed to have water separate from the released material. The injection of gas into the thick fine tailings may be performed before the thick fine tailings are flocculated by the chemical flocculant, while they are being flocculated by the chemical flocculant, or just after they have been flocculated by the chemical flocculant. The injection of gas can be performed “in-line” (meaning along the same flow direction as the thick fine tailings) such as with a co-annular gas injector as described below. In another implementation, the injection of gas can be performed with a rectangular air injector as described below. Either air injector can inject the gas via multiple inlets and from different angles. The gas may be injected near or proximate to the contacting of chemical flocculant.

As described below in relation to experiments, the methods described above may result in a lower dosage of polymer flocculant being required for a given dewatering value.

### Gas Injection Device

A gas injection device can be used for dewatering thick fine tailings. One implementation of the gas injection device is shown in FIG. 1. In some implementations the thick fine tailings are oil sands mature fine tailings (MFT), and for illustrative purposes, the gas injection device is described below in the context of MFT, although it should be understood that the device can be used in other implementations where the thick fine tailings are not MFT.

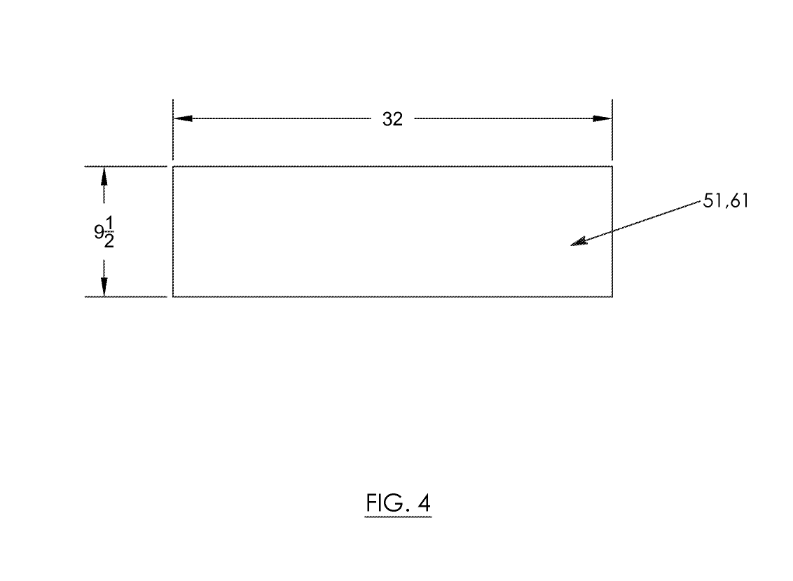

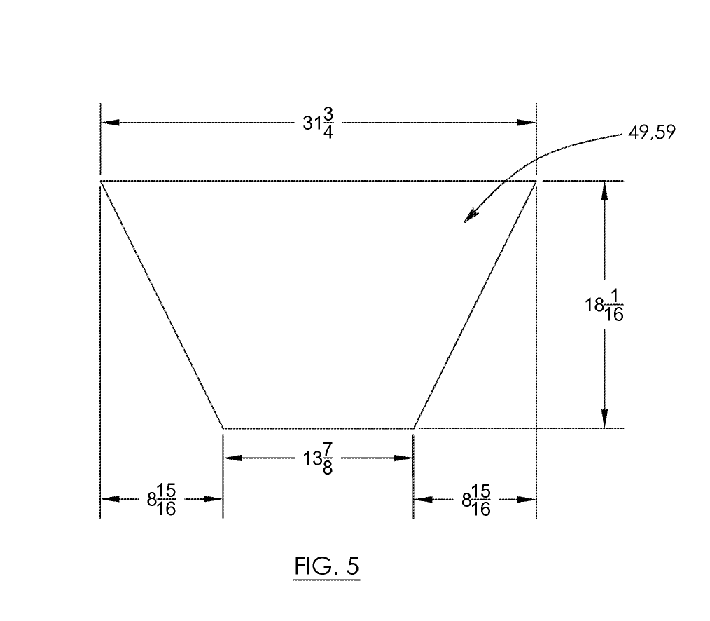

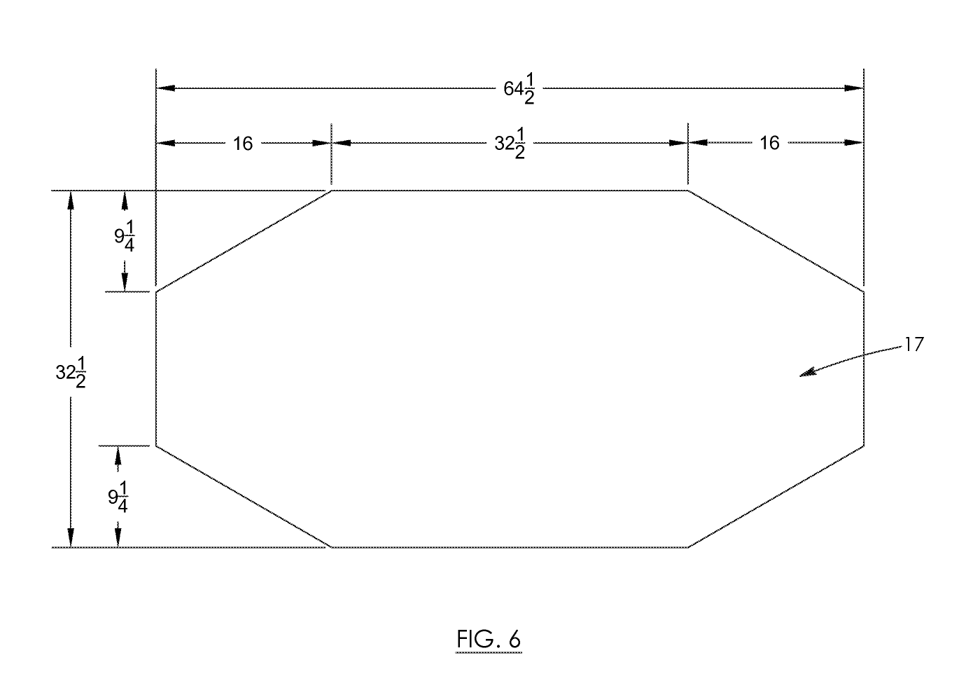

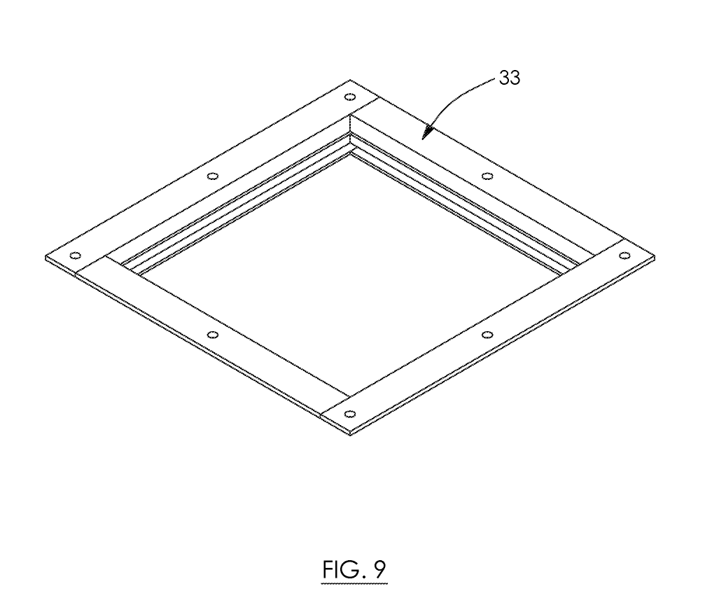

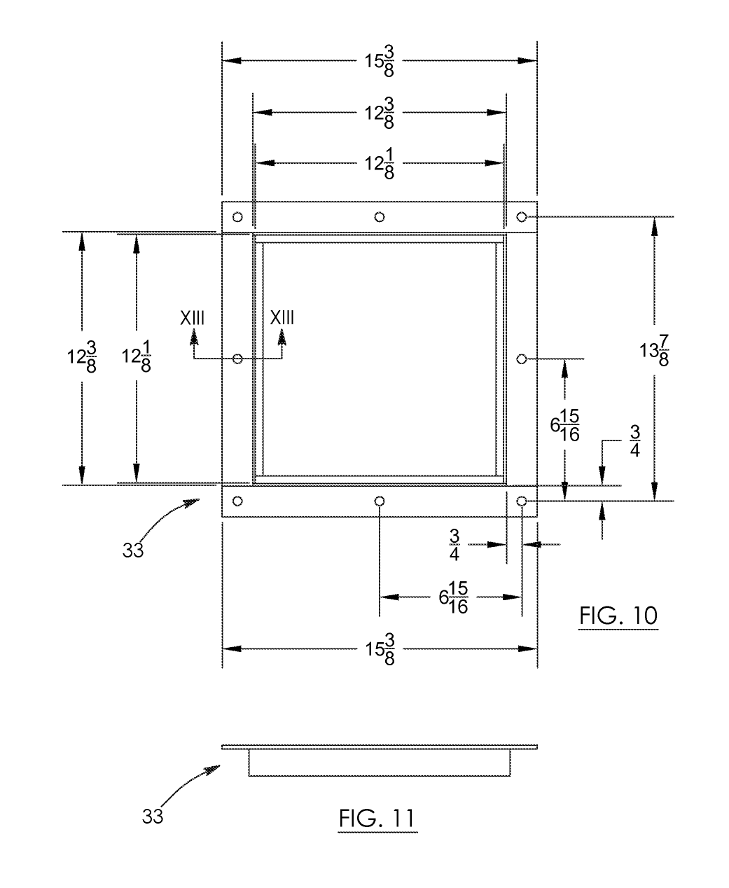

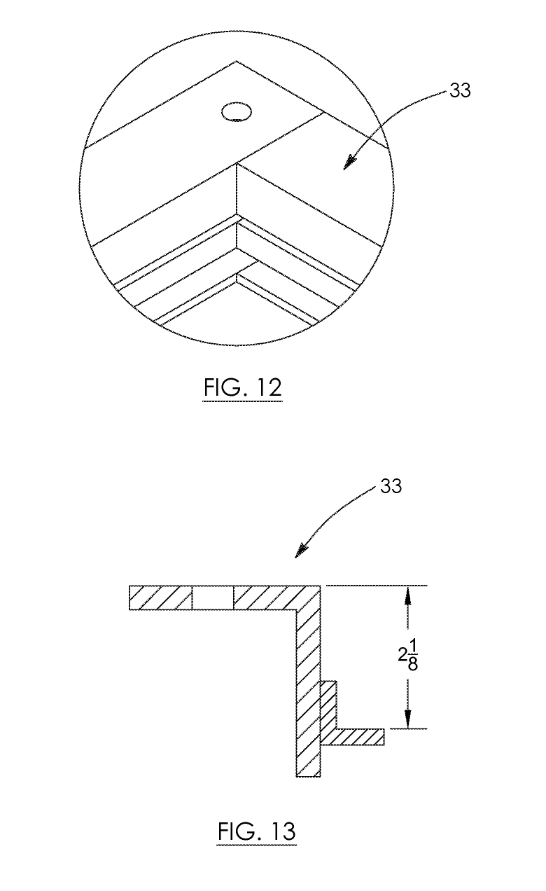

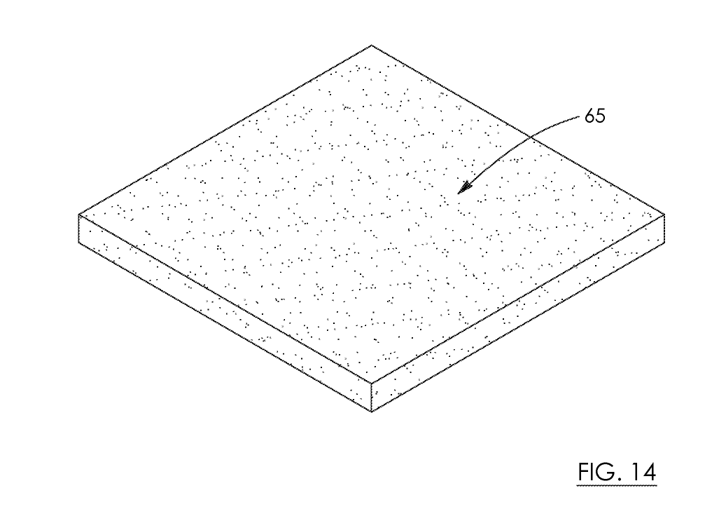

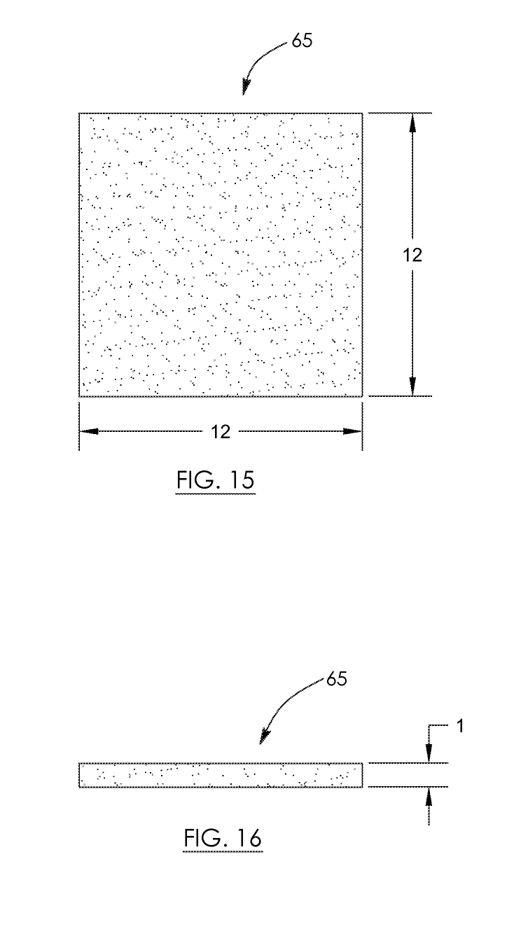

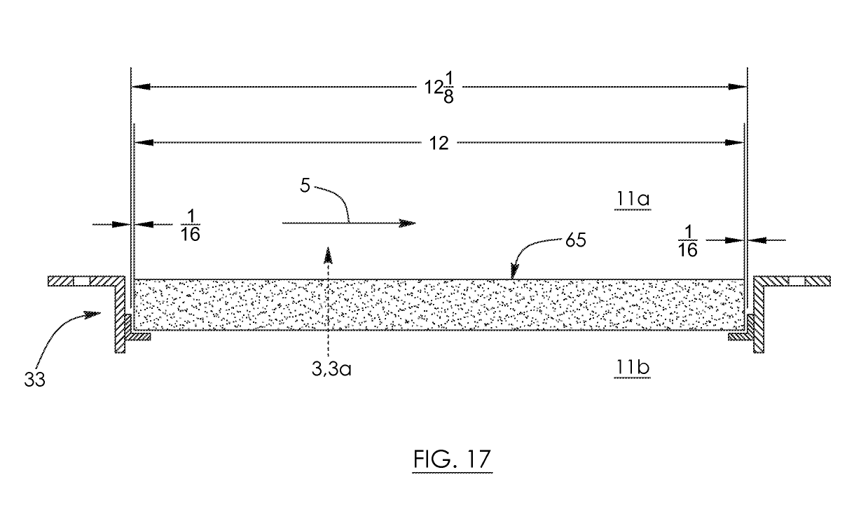

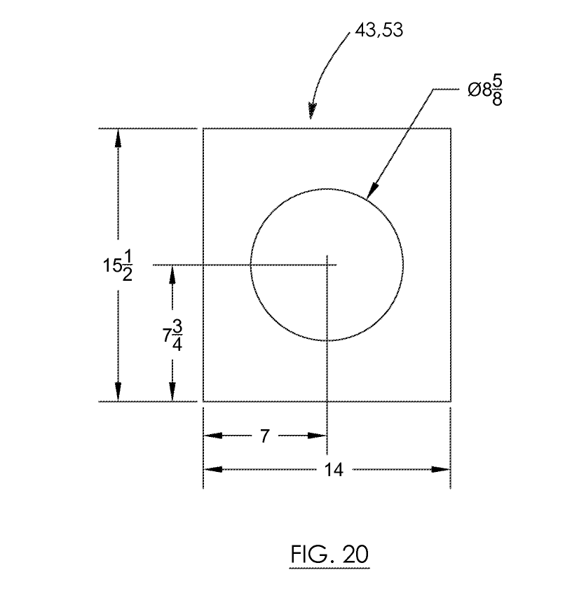

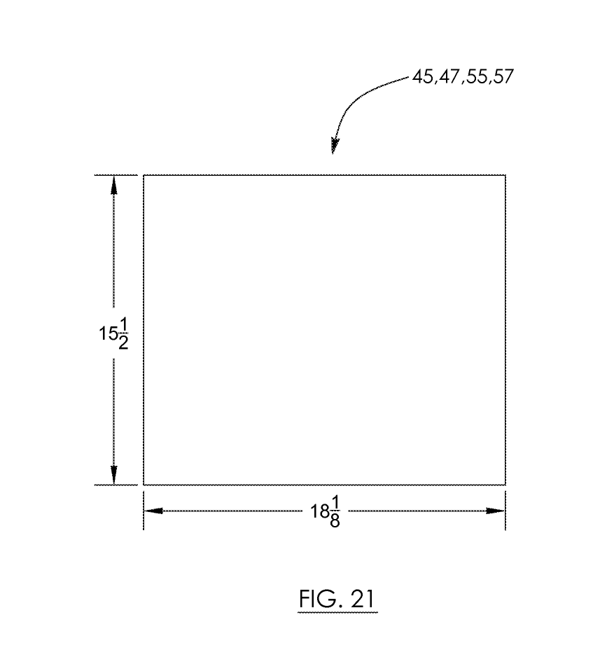

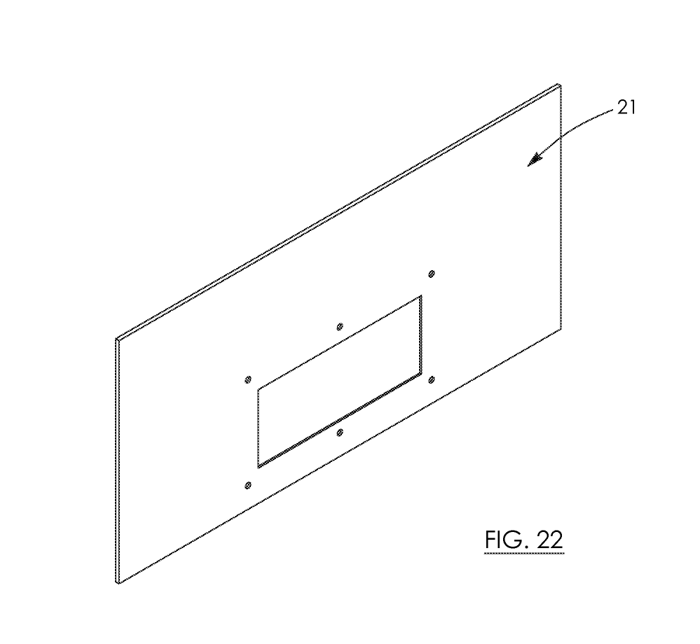

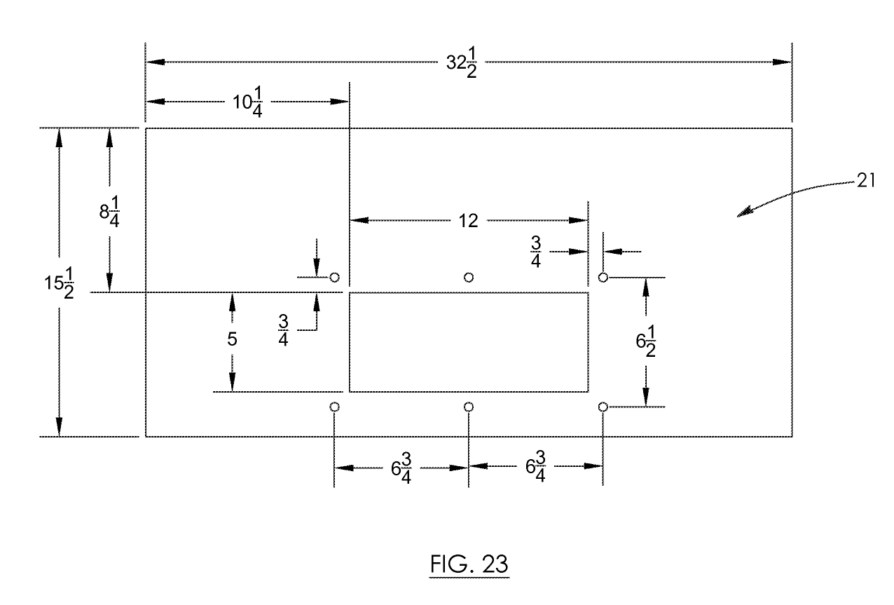

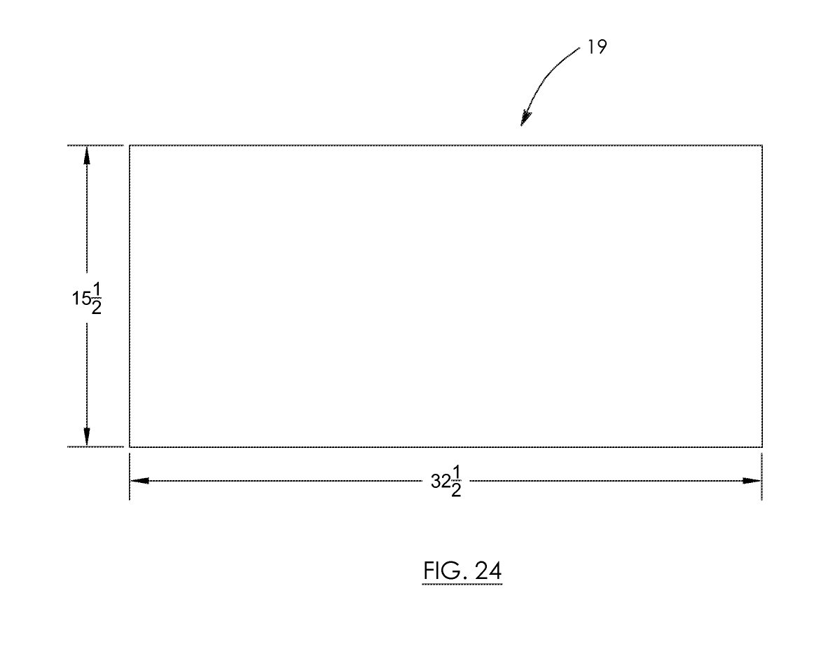

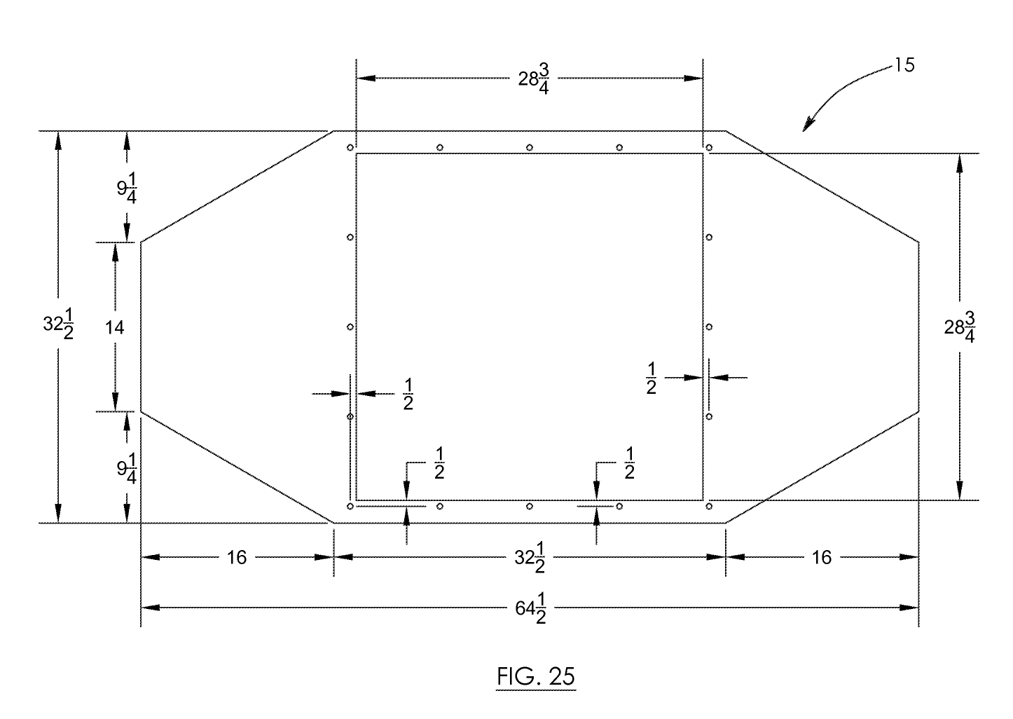

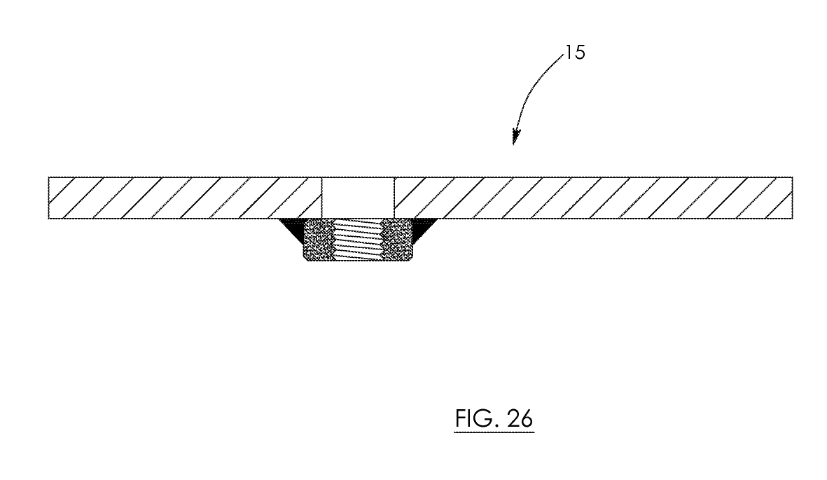

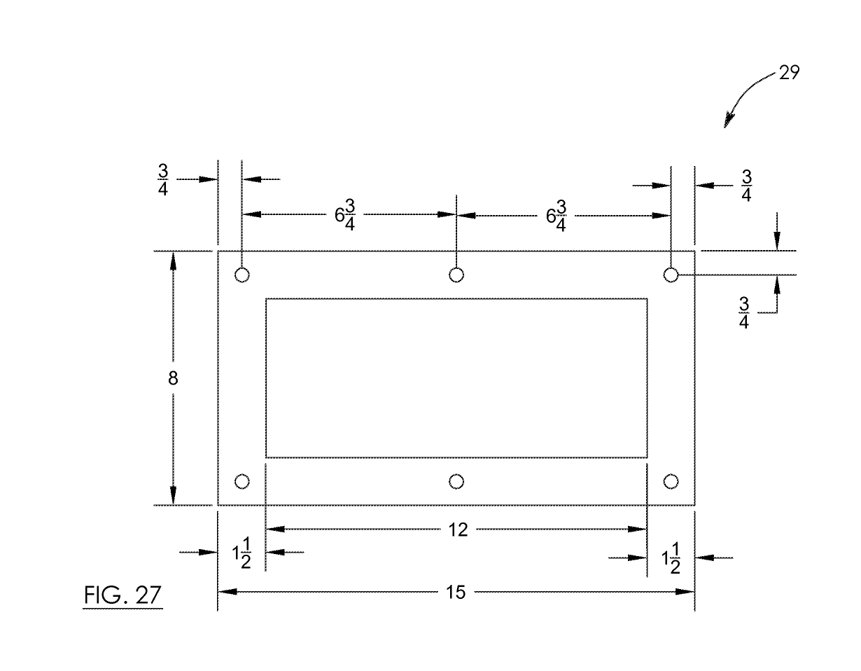

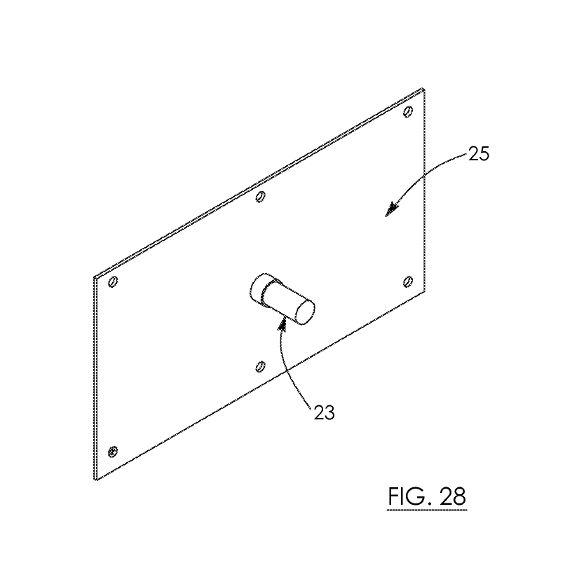

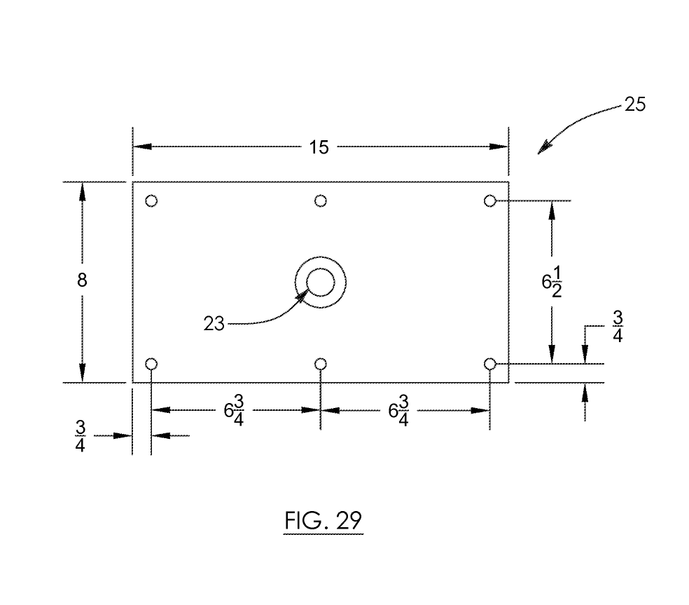

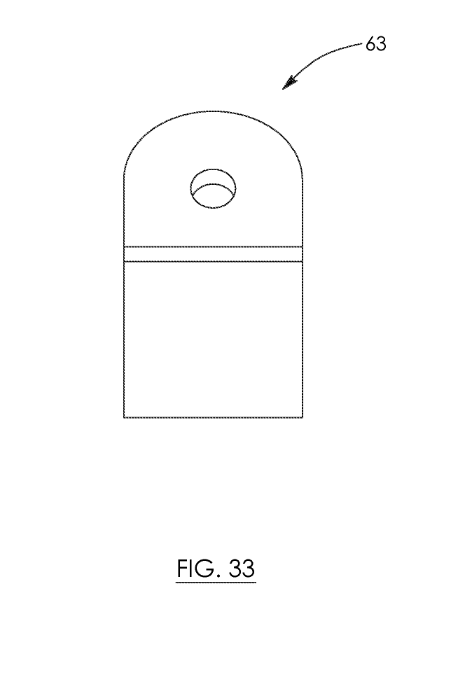

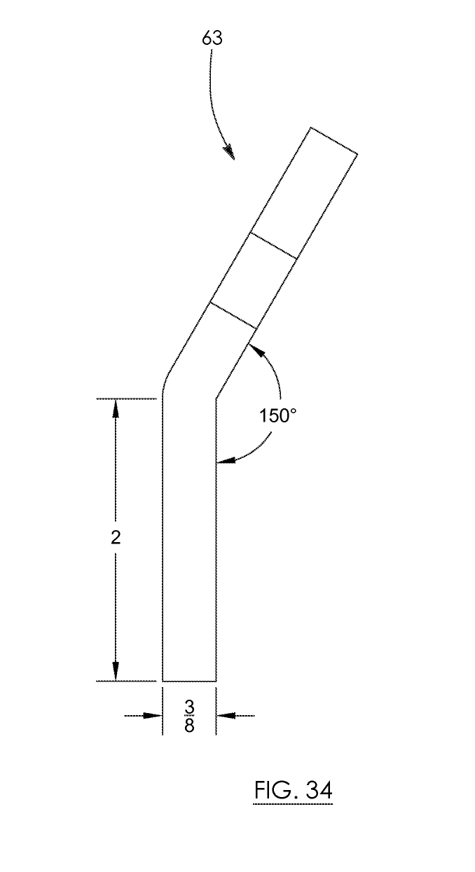

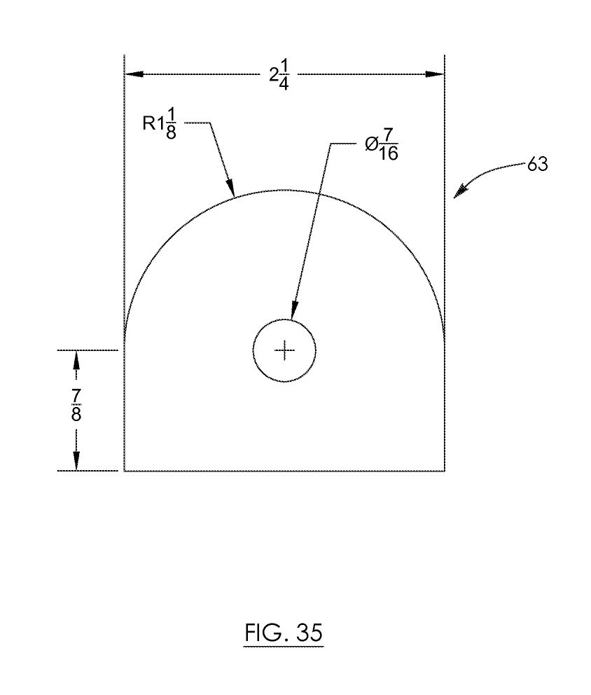

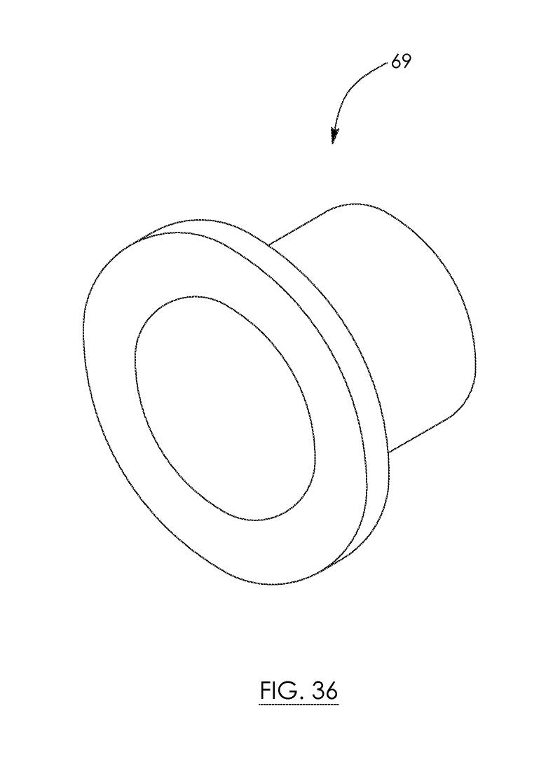

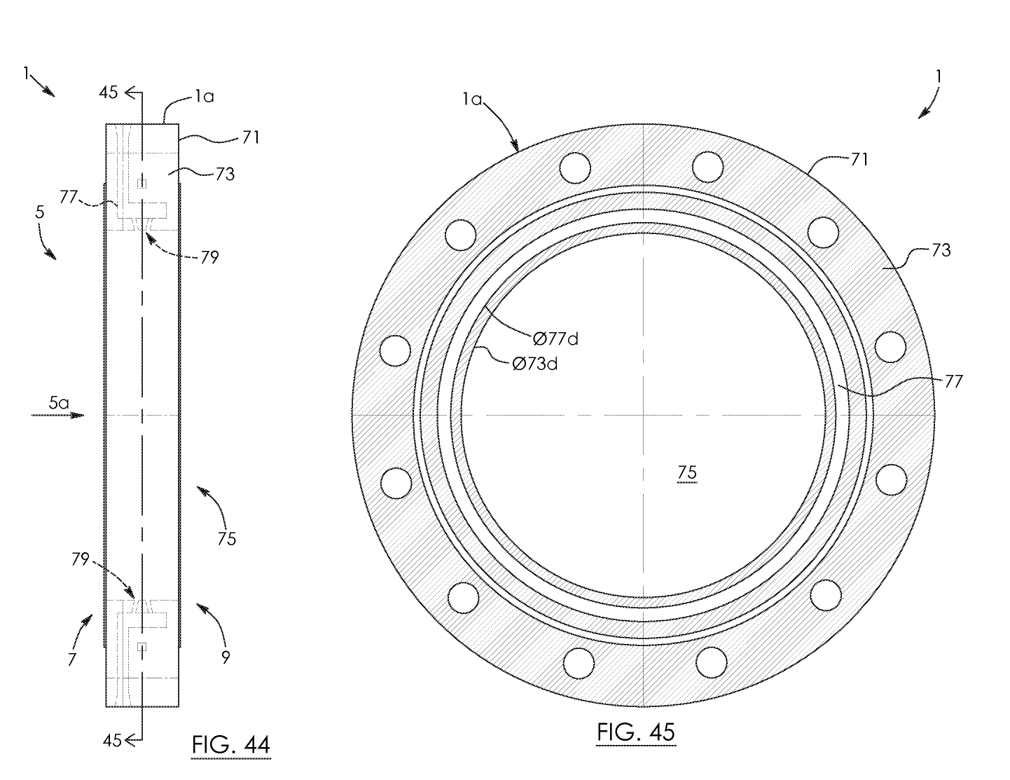

The device (1) includes an inlet (7) for receiving MFT (5) and an outlet (9) for releasing a MFT (5) after it has been treated by the device (1) (i.e., gas-treated MFT). The device (1) also includes a gas injector (shown as 11 in FIGS. 1-38 and as 1a in FIGS. 44 and 45) disposed between the inlet (7) and the outlet (9), the gas injector (11,1a) introducing gas (3) into the MFT (5) thereby producing the gas-treated MFT (5) and facilitating water release in the gas-treated MFT (5) via flocculation of same.

Different implementations of the gas injector (11,1a) will now be described. The gas injector may include one or more diffuser plates, one or more pipe sparger devices, and/or one or more co-annular injectors, for example.

### Box Type Gas Injector (11)

In some implementations and referring to FIG. 1, an injection device (1) is provided for carrying out the in-line gas or air injection method briefly described hereinabove. Indeed, as better shown in FIGS. 1-3, there may be provided an injection device (1) for injecting fine bubbles of gas (3) into a fluid flow (5) of MFT before release, either before, during, or after said tailings are flocculated. The injection device (1) includes an inlet (7), an outlet (9), and a gas injector (11), referred to herein as a transitional housing (11). The inlet (7) is used for receiving the fluid flow (5), and conversely, the outlet (9) is used for releasing the fluid flow (5). As the injection device (1) may be used with a pipeline carrying a fluid flow (5) of MFT, the inlet (7) and the outlet (9) of the injection device (1) may be configured for appropriate connection with the pipeline, by means of a suitable component, such as a flange connection.

Returning now to the injection device (1) as exemplified in FIGS. 1-3, the transitional housing (11) is disposed between the inlet (7) and the outlet (9), and includes at least one interface (13) separating the transitional housing (11) between a first chamber (11a) or channel where fluid flow (5) entering the inlet (7) is allowed to travel before exiting from the outlet (9), and a second chamber (11b) or channel where gas (3) therein is pressurized or compressed. The at least one interface (13) may be configured for allowing small bubbles of gas (3) from the second chamber (11b) or channel to be introduced into the fluid flow (5) of the first chamber (11a) or channel in order to aid in water release of the MFT coming out of the injection device (1). In some implementations, the gas (3) being introduced into the fluid flow (5) of MFT is compressed air (3a), and the transitional housing (11) has cross-sections of different configurations between the inlet (7) and the outlet (9). In one implementation, the cross-section of the transitional housing (11) may be rectangular. These variations in the cross-section of the transitional housing (11) are intended namely to promote a better mixture of the material, and to allow for a better injection of the fine bubbles of air (3a) into the fluid flow (5), as will be explained in greater detail hereinbelow.

In some implementations, as shown in FIGS. 1-3, the transitional housing (11) may include an inlet (7) having a substantially circular cross-section, and a main section (14) having a substantially rectangular cross-section. Similarly, the transitional housing (11) may include an outlet (9) having a substantially circular cross-section. Among the various advantages provided by the present injection device (1), going from a smaller cross-section (e.g., circular), typically provided by corresponding pipeline carrying a fluid flow (5) of MFT to be treated, to a larger and greater cross-section (e.g., rectangular), allows to slowdown the fluid flow (5) to be treated, thereby allowing said fluid flow (5) to spend more time cooperating with the at least one interface (13) separating the air layer (i.e. second chamber (11b) or channel) from the fluid layer (i.e. first chamber (11a) or channel), so as to allow for better and more efficient injection of fine bubbles of air (3a) into the fluid flow (5) travelling above the at least one interface (13), so as to further promote or enhance water release from the MFT, due to the introduction of said fine bubbles of air (3a) into the fluid flow (5).

The size of the bubbles may be provided so as to not be too “large”, in order to avoid that they coalesce and “bubble out”. The injection device (1) may be configured to allow appropriately sized bubbles of air (3a) to be introduced into the fluid flow (5) in order to have fine bubbles of gas (3) in the fluid flow (5).

As shown in the accompanying drawings, the transitional housing (11) may include top and bottom plates (15,17), and a pair of opposite side plates (19,21), so as to provide the transitional housing (11) with at least one substantially rectangular enlarged cross-section, for the reasons briefly detailed hereinabove (slowing down the fluid flow (5), enabling the fluid flow (5) to spend more time cooperating with the at least one interface (13) so as to receive therefrom corresponding fine bubbles of gas (3) in order to promote dewatering, etc.

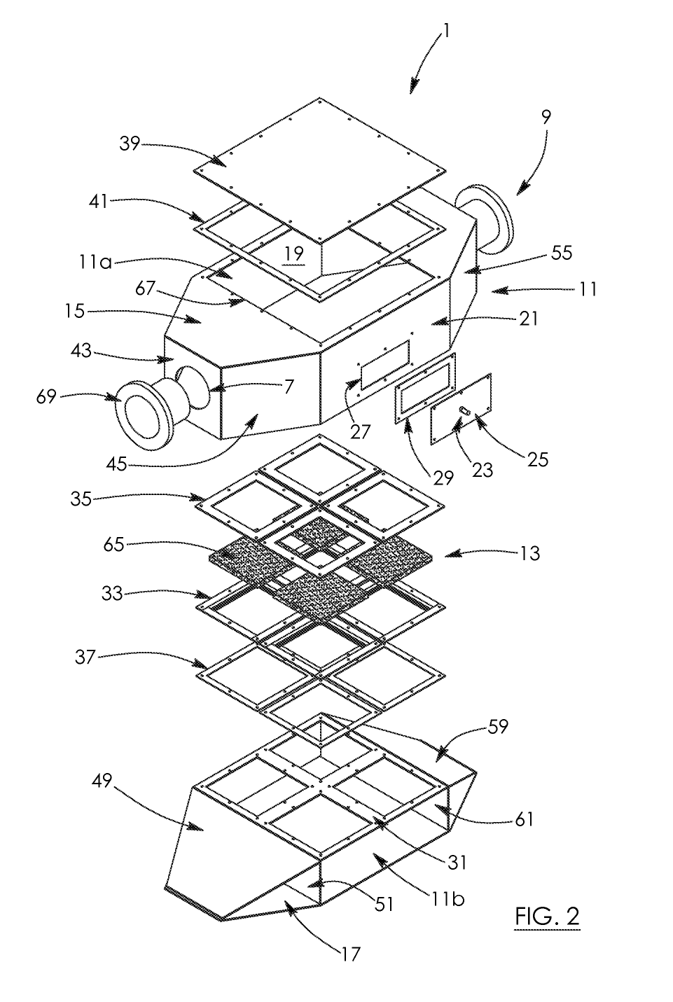

As better shown in FIGS. 1-3, the transitional housing (11) may include a side nozzle plate (21), provided with a nozzle (23) for receiving air (3a) from a source of pressurized air (3a). The nozzle (23) may be provided on a side nozzle cover (25) being removably mountable onto a corresponding opening (27) of the side nozzle plate (21). As better shown in FIG. 2, the injection device (1) also may include a nozzle plate gasket (29) removably mountable between a rim of the opening (27) of the side nozzle plate (21) and the side nozzle cover (25) in order to provide a seal thereinbetween. Other suitable ways of introducing an appropriate gas (3), such as air (3a) for example, or any other suitable gas or fluid to be injected into an upper fluid layer in the form of fine bubbles for promoting dewatering of the fluid flow (5) of MFT, may be used. In fact, two chambers (11a,11b) or channels separated by at least one interface (13) may be used, and each chamber (11a,11b) or channel being configured for receiving a corresponding fluid, and the at least one interface (13) being further configured for allowing the passage of only one fluid from one chamber (11b) to the other (11a), so that the introduction of this acting fluid that will be allowed to pass through the at least one interface (13) would cause a corresponding desired effect into the fluid flow (5) of the chamber (11a) to be processed. Thus, the second chamber (11b) is not limited to the presence of a gas (3), and another appropriate type of “fluid” could be used depending on the particular applications for which the present injection device (1) is intended for, and the desired end results.

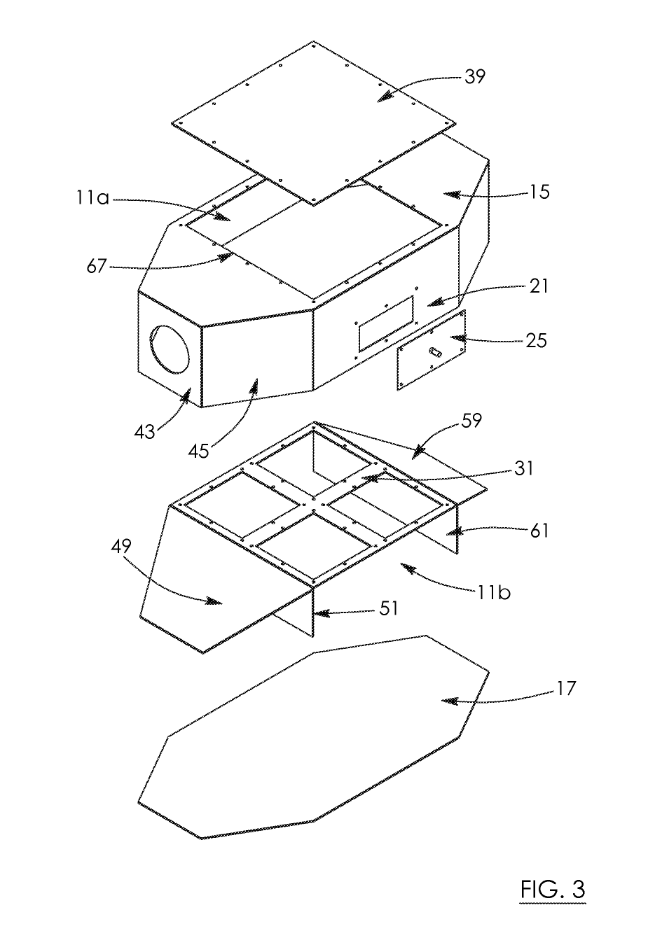

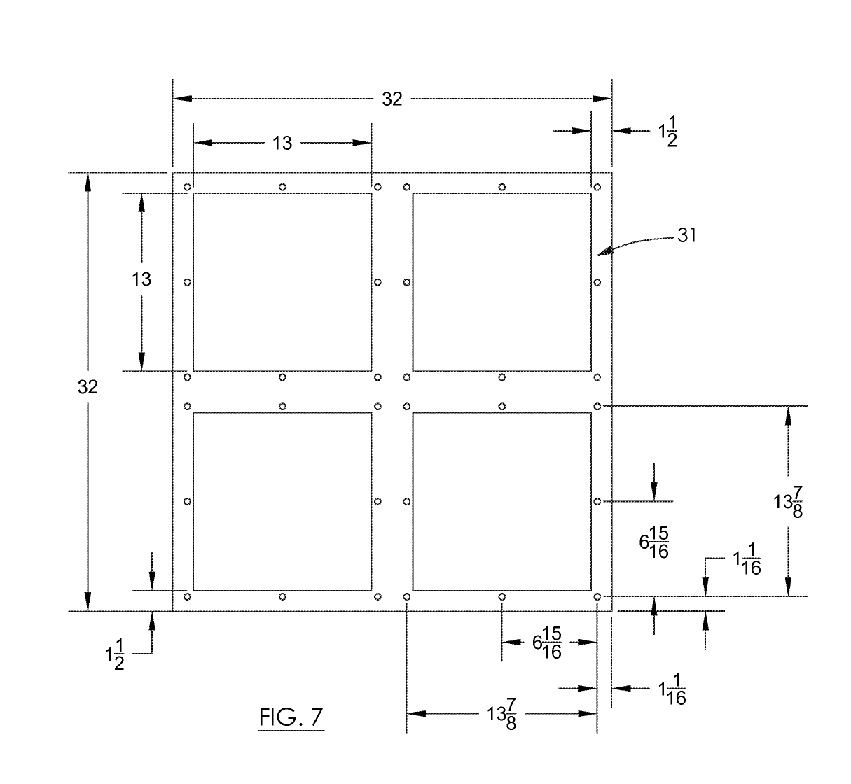

FIGS. 1-3, and more particularly to FIGS. 2 and 3, show different components which may be used with the injection device (1). Indeed, there is shown how the transitional housing (11) may include an interface plate (31) configured for receiving the at least one interface (13). An example of a possible interface plate (31) is illustrated in FIG. 7. The interface plate (31) may be supported by a pair of first and second support plates (51,61), as better shown in FIGS. 2 and 3. Other suitable types of dispositions and components can be used for extending at least one interface (13) within a transitional housing (11) so as to provide a corresponding boundary between a first chamber (11a) and a second chamber (11b), so as to allow the passage of a fluid, such as a gas (3), or simply compressed air (3a), from one chamber (11b) into the next.

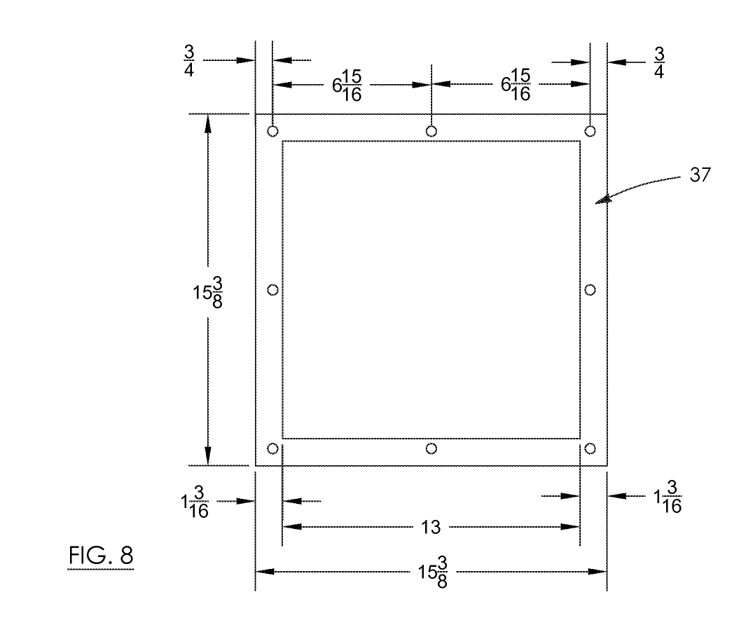

The injection device (1) may also include a diffuser frame (33) removably mountable onto the interface plate (31) of the transitional housing (11) for receiving the at least one interface (13). FIGS. 9-13 illustrate a possible manner of how to fabricate a diffuser frame. There may be provided a diffuser frame (33) for each interface (13) being used, as exemplified in FIG. 2, the diffuser frame (33) may simply include one single piece being provided with an appropriate number of corresponding recesses for receiving a corresponding number of interfaces (13) to be used with the injection device (1). In FIG. 2, the diffuser frame (33) may include four corresponding recesses for receiving four corresponding interfaces (13), which may come in the form of porous ceramic diffuser plates (65), as will be explained in greater detail below.

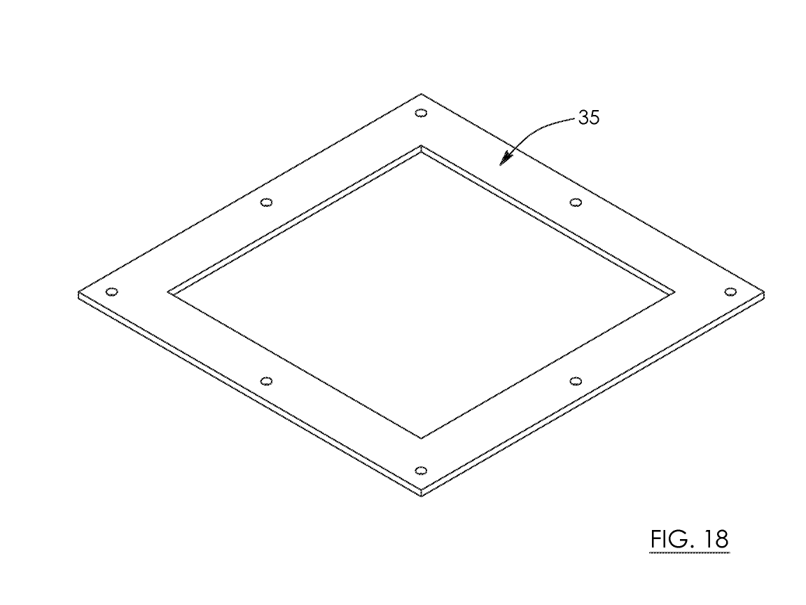

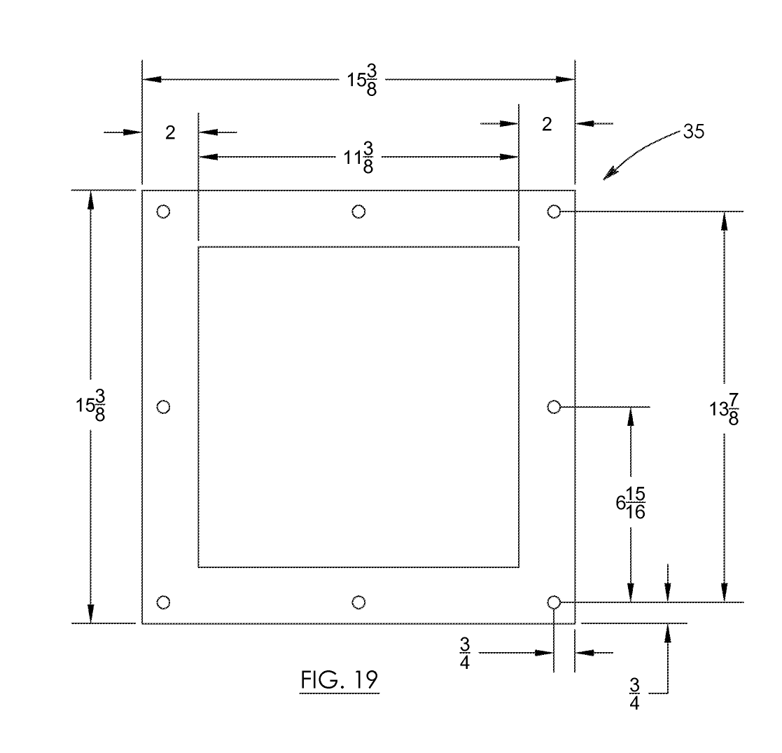

Accordingly, the injection device (1) may also include a corresponding diffuser cover (35) removably mountable onto the diffuser frame (33) for securing the at least one interface (13) onto said diffuser frame (33). An example of a possible diffuser cover is illustrated in FIGS. 18-19.

Similarly, the injection device (1) may also include an interface gasket (37) removably mountable between the interface plate (31) and the diffuser frame (33) in order to provide a seal between the interface plate (31) and the diffuser frame (33). An example of a possible interface gasket (37) is illustrated in FIG. 8. Indeed, given that the at least one interface (13) is the boundary that separates the fluid layer (e.g., first chamber (11a)) from the air layer (i.e. second chamber (11b)) within the transitional housing (11), the interface gasket (37) may provide a suitable seal between the interface plate (31) which is intended to receive the at least one interface (13), and the diffuser frame (33) which is intended to secure the same against the interface plate (31), by appropriate affixing, such as welding, bolting or the like. In some implementations, components cooperating with one another, such as for example, the diffuser plate (65) cooperating with the diffuser frame (33), may be further provided with suitable sealing means, so as to ensure a proper seal or boundary between the first and the second chambers (11a,11b). As illustrated in the accompanying drawings, several of the components of the present injecting device (1) may be removably connectable onto one another so as to allow certain components to be removed for easy inspection, maintenance and/or replacement.

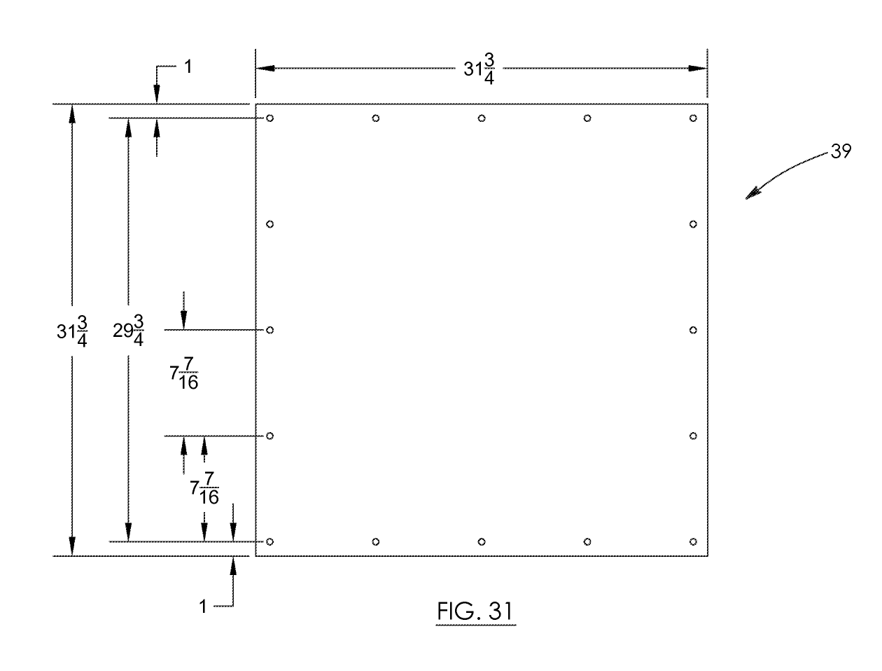

As better shown in FIGS. 2 and 3, transitional housing (11) may also include an access opening (51), and accordingly, the injection device (1) may include a housing cover (39) removably mountable onto the transitional housing (11) for covering said access opening (67). An example of a possible housing cover (39) is illustrated in FIG. 31, and the presence of such a housing cover (39) being removably mountable onto the top plate (15) of the transitional housing (11), for example, further enhances the fact that the present injection device (1) may allow for simplified inspection, maintenance and/or replacement of parts, by accessing to the inside of the transitional housing (11) via the access opening (67) provided on the top plate (15) of the transitional housing (11).

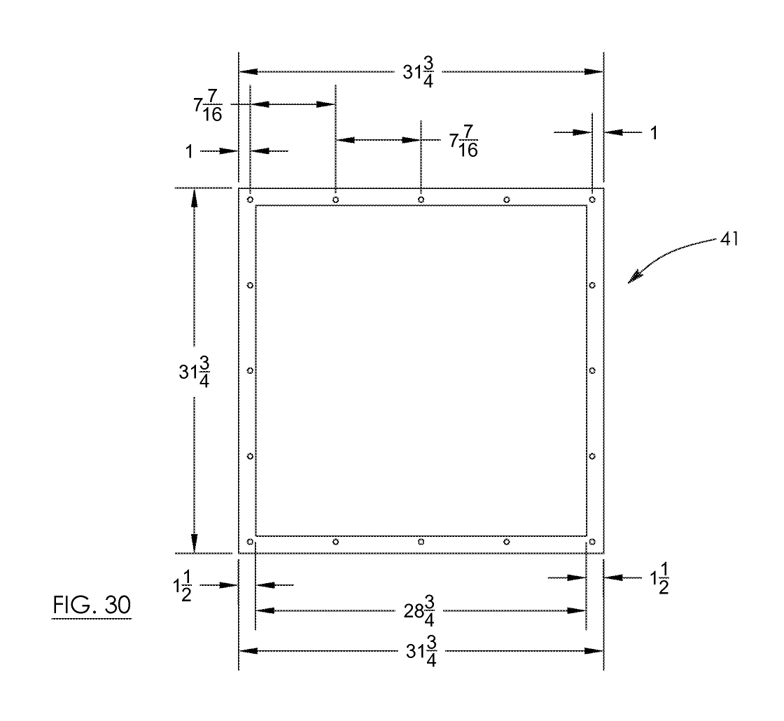

Accordingly, the injection device (1) may also include a housing gasket (41) removably mountable between a rim of the access opening (67) of the transitional housing (11) and the housing cover (39) in order to provide a seal, as seen in FIG. 2. An example of a possible housing gasket (41) is illustrated in FIG. 30. As previously explained, the present injection device (1) may be provided with suitable sealing means so as to ensure a proper operation, and so as to prevent any leakage of fluid flow (5) from one chamber (11a,11b) to another.

Because the present injection device (1) may be easily connected in-line with a corresponding pipeline carrying a fluid flow (5) of MFT to be processed, the transitional housing (11) can also include a face plate (43) about which is positioned the inlet (7), and further has an end plate (53) about which is positioned the outlet (9), as seen in FIGS. 1 and 2. The inlet (7) and the outlet (9) of the transitional housing (11) may be provided with a corresponding component for allowing an appropriate connection to the pipeline, and the inlet (7) and the outlet (9) of the injection device (1) may be respectively provided with a corresponding pipe and flange connection (69).

Referring now to the particular construction of one implementation of the transitional housing (11), and as better shown in FIGS. 1-3, the transitional housing may include a pair of front corner plates (45,47), each front corner plate (45,47), extending between the face plate (43) and a corresponding side plate (19,21), as well as a pair of rear corner plates (55,57), each rear corner plate (55,57) extending between the end plate (53) and a corresponding side plate (19,21). The presence of such corner plates (45,47,55,57) allows a proper and progressive transition of the fluid flow (5) between the inlet (7) and the main section (14), and between said main section (14) and the outlet (9), similarly to the effects provided by the ramps (49,59), as explained in greater detail hereinbelow.

The transitional housing (11) may also include front and rear support plates (51,61) extending within the second chamber (11b) for supporting the at least one interface (13), and more particularly, for supporting the interface plate (31), as previously explained.

In another implementation, the transitional housing (11) includes a front top ramp (49) extending from a bottom portion of the inlet (7) to an upper portion of the front support plate (51), and a rear top ramp (61) extending from an upper portion of the second support plate (61) to a bottom portion of the outlet (9). The presence of such corresponding ramps (49,59) allow for the transition of the fluid flow (5) from the inlet (7) to the main section (14) to be more progressive so as to avoid any abrupt changes in the fluid flow (5), thus permitting the small bubbles of air (3a) to be injected into the fluid flow (5) for dewatering of the MFT. Similarly, the rear ramp (59) may allow for a more progressive transitional change of the fluid flow (5) from the main section (14) out of the outlet (9) of the injection device (1), for continuation into the pipeline before release and subsequent dewatering of the MFT.

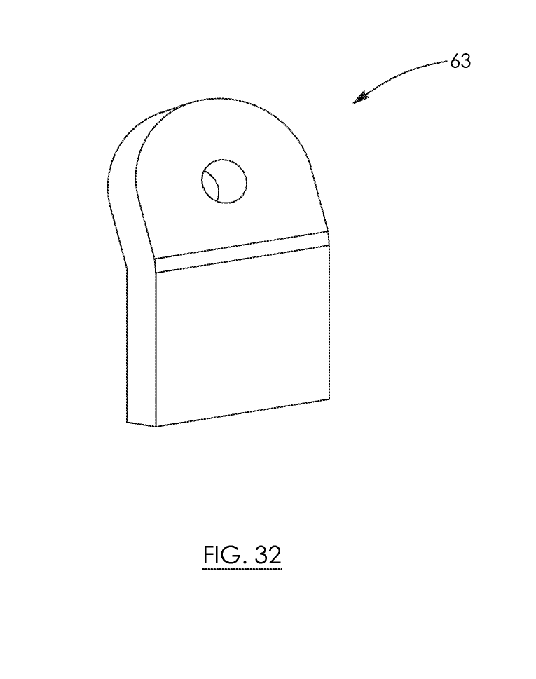

In some implementations, and as shown in FIG. 1, the housing cover (39) may be removably securable against a top plate (15) of the transitional housing (11) by means of lifting lugs (63), and the lifting lugs (63) can be mounted onto corner plates (45,47,55,57) of the transitional housing (11). An example of a possible lifting lug (63) is shown in FIGS. 32-35. The housing cover (39) may be removably securable against a corresponding portion of the transitional housing (11) by any other suitable means, so as to enable a removable and selective access to the inner components of the injection device (11) for easy inspection, maintenance and/or replacement of components.

In other implementations, the at least one interface (13) includes at least one diffuser plate (65). More particularly, the at least one interface (13) may include a plurality of ceramic diffuser plates (65), and according to FIG. 2 for example, may more particularly include four ceramic diffuser plates (65). As a result, the plates, frames and gaskets of the present injection device (1) are configured in accordance with said ceramic diffuser plates (65), so as to ensure a proper operation of the injection device (1), as well as an appropriate seal between the different layers.

As previously explained, the ceramic diffuser plate (65) can be a porous ceramic diffuser plate (65) which is configured for allowing gas (3), such as air (3a) for example, to pass therethrough, while acting as an appropriate boundary to the passage of the fluid flow (5) travelling above the at least one interface (13). The pores of the diffuser plate may be sized in conjunction with the gas pressure and the fluid flow pressure such that the gas bubbles into the fluid flow and the fluid does not penetrate or leak through the diffuser plate. The configuration of the present injection device (1) allows for the ceramic diffuser plates (65) to be easily replaced, and interchanged, due to the removable aspects of the present injection device (1), and as a result, particular diffuser plates (65) to be used for certain applications may be used, whereas other types of diffuser plates (65), with other properties, may be used for other applications or other types of fluid flows (5) to be processed with the present injection device (1).

The at least one interface (13), which can provide a boundary between the fluid layer (i.e. first chamber (11a) or channel) travelling above the lower air layer (i.e. second chamber (11b) or channel), may come in other shapes and forms, depending on the particular applications for which the present injection device (1) is intended for, and the desired end results. Moreover, the at least one interface (13) may be configured so as to adjustably be able to calibrate and modify the size of bubbles of air (3a) being introduced into the fluid flow (5), whether directly, by activating a corresponding component of the at least one interface (13), or remotely, by sending appropriate control signals. However, the injection device (1) may also be very simple assembled, so as to be able to be manufactured in a very cost effective manner, and so as to ensure that the injection device (1) can be operated with little or practically no maintenance.

In other implementations, the injection device (1) can be a quill-type gas injector, which may include a perforated pipe sparger extending into the flow of MFT. One or more perforated pipe sparger may be provided to extend into the flow of the MFT and the perforations may be configured and sized to provide the gas bubbles into the MFT. The perforated pipe sparger device may extend from one internal wall of the MFT pipeline until close to the opposed internal wall so as to be substantially normal with respect to the flow direction of the MFT, or may have other configurations and orientations.

Co-Annular Gas Injector (1a)

In other implementations, the injection device (1) may inject fine bubbles of gas (3) such as air (3a), into the fluid flow (5) in a peripheral manner via a gas injector (1a) exemplified in FIGS. 44 and 45. In this implementation, the injection device (1) may have a gas injector (1a) positioned between the inlet (7) and the outlet (9) which can inject air (3a) into the fluid flow (5) either just before the chemical flocculant is added, during addition of the chemical flocculant, or just after addition of the chemical flocculant. The gas injector (1a) may be configured “in-line” so as to inject gas (e.g., air) (3a) at multiple points into the fluid flow (5). A fluid direction (5a) is defined by the flow of fluid (5) from the inlet (7) to the outlet (9), and may be conveyed via a cylindrical pipe or pipeline composed of multiple sections. These sections of pipe can include an inlet pipe and an outlet pipe. The gas injector (1a) can be mounted about such a fluid flow (5) and/or pipe sections, so that if the pipe is circular for example, the gas injector (1) is mounted co-axially with the inlet and outlet pipes, and air (3a) is injected into the fluid flow (5) along multiple radial directions.

In some implementations, the air injector (1a) includes at least one circular flange (71). The at least one flange (71) can be two flanges (71), each flange (71) mounted about a separate section of pipeline and abutting each other. The flange (71) may be configured to connect two sections of the pipeline so as to inject air (3a) into the fluid flow (5) carried by said sections. The flange (71) may be a cylindrical or annular device which allows for the passage of the fluid flow (5) therethrough, and which allows for gas (3) and/or air (3a) to be injected radially into the fluid flow (5).

In some implementations, the flange (71) includes a rim (73) and a circular passage (75) defined thereby. The rim (73) can have an inner or internal diameter (73d) which defines the circumference of a cross-sectional plane through which the fluid flow (5) passes through. The internal diameter (73d) may be about 12″, but may also be various other diameters according to the design of the dewatering pipe assembly, e.g. 2″ to 24″. The rim (73) allows for the injection of air (3a) in a radial manner, which can mean that air (3a) is injected into the fluid flow (5) along multiple directions defined by the radius of the rim (73). The rim (73) encircles the passage (75), which can be any space, void, hole, etc. through which the fluid flow (5) can pass.

In some implementations, the rim (73) houses a distribution chamber (77) which is positioned circumferentially within the rim (73) at a distribution diameter (77d). The distribution chamber (77) receives air (3a) under pressure from an air supply, and transmits the air (3a) into the fluid flow (5), which can be done under pressure. The distribution diameter (77d) may be greater than the internal diameter (73d) of the rim (73). More particularly, the distribution diameter (77d) can be 13¼″. A plurality of orifices (79) can be distributed circumferentially about the rim (73) or the internal diameter (73d), and oriented in a radial direction. They may define a conduit such that the orifices (79) allow for the passage of pressurized air (3a) from the distribution chamber (77) into the fluid flow (5). The orifices (79) can be positioned at angular intervals along the internal diameter (73d) and extend radially inward into the rim (73) from the internal diameter (73d) to the distribution diameter (77), thereby connecting the distribution chamber (77) to the circular passage (75). The orifices (79) can be positioned at angular intervals of 60 degrees, resulting in about six orifices (79) in the rim (73).

The orifices may be sized to provide the desired size and flow rate of gas bubbles. In some implementations, each orifice may be sized between about 1 mm and about 1.5 mm in diameter, for example about 1.2 mm in diameter.

Having described some of the components and features related to injecting fine bubbles of gas (e.g., air (3a)) into the fluid flow (5), an additional technique to promote dewatering of the thick fine tailings, e.g., MFT, is now described. A specific amount of chemical flocculant or polymer, referred herein as a “polymer dosage” (81), can be added to the fluid flow (5) to aid in its dewatering, as the examples described below demonstrate. The polymer dosage (81) can be added to the fluid flow (5) by techniques such as with a polymer dosage mechanism (83). The polymer dosage (81) can be added either before or after air (3a) is injected into the fluid flow (5) depending on multiple requirements such as, but not limited to, site constraints, fluid flow (5) characteristics, the desired amount of dewatering, etc. The polymer dosage mechanism (83) can be a stand-apart component to the injection device (1), or it can be integrated therewith, such as with the transitional housing (11), for example.

The injection device (1) and corresponding parts can be made of substantially rigid materials, such as metallic materials (e.g., stainless steel), hardened polymers, composite materials, and/or the like, whereas other components, may be made of a suitably malleable and resilient material, such as a polymeric material (e.g., plastic, rubber, etc.), and/or the like, depending on the operating conditions and design of the dewatering system in which the injection device (1) in used.

Furthermore, the present air injection device (1) is relatively simple and easy to use, as well as is simple and easy to manufacture and/or assemble, and provides for a cost effective manner of processing thick fine tailings, namely in order to promote and/or aid in the water release of thick fine tailings.

The injection device (1) provides for a manner to inject a gas (3), such as compressed air (3a) for example, into an in-line fluid flow (5) of thick fine tailings, in the form of small bubbles of air (3a), for the purpose of enhanced dewatering. The simplest manner in which this can be carried out would be to introduce a given inlet (7) into a fluid flow (5) of thick fine tailings so as to blow air (3a) into the fluid flow (5). However, such a rudimentary technique is thought to cause big clumps of air (3a) inside the fluid, which is why the injection device (1) with its corresponding components and features has been designed, so as to ensure an improved cooperation between the fluid flow (5) travelling along the at least one interface (13), and the fine bubbles of air (3a) being introduced into the fluid flow (5) through the at least one interface (13).

The gas injector (11) can be an air injection box designed to admit or introduce small bubbles of air (3a) into the thick fine tailings stream. In one implementation, the cross-section of the thick fine tailings flow is changed from a circular to a rectangular configuration as it passes through the box, and during this time, it passes over four 1′×1×1″ ceramic plates (these being readily available through appropriate vendors) which push air bubbles into the flow, given that aeration helps with water release. The pressurized air chamber (11b) in the bottom and a flowing fluid chamber (11a) in the top can be separated by sealed ceramic plates, and for convenience, standard flange fittings are used so that the device (1) can literally be dropped into place, bolted up to, and run with an air compressor. Pressure in the box can be very low due to the proximity to the release point (atmosphere).

Some implementations of the device may be connected in-line with a corresponding pipeline carrying a fluid flow (5) of thick fine tailings to be treated and dewatered. Moreover, the construction of the present injection device (1) enables for corresponding components to be inspected, maintained and/or replaced, due to the removable manner in which they can be connected, and the corresponding access openings (27,67) which enable to access corresponding inner components of the injection device (1). Moreover, as previously explained, the presence of a wide, and of a long, transitional housing (11), allows not only to slowdown the fluid flow (5) of thick fine tailings provided from the pipeline through the inlet (7) of the injection device (1), but also allows for such fluid flow (5) to spend more time cooperating with the at least one interface (13) so that suitable fine bubbles of gas (e.g., air (3a)) can be injected into the fluid flow (5) in order to promote dewatering of the thick fine tailings. Furthermore, the presence of ramps (49,59) between the inlet (7) and the main section (14) of the transitional housing (11), and between the main section (14) of the transitional housing (11) and the outlet (9), allow for a progressive and improved cooperation of the fluid flow (5) inside the transitional housing (11), for further promoting an enhanced dewatering of the thick fine tailings flowing through the injection device (1).

The present injection device (1) is not limited to the presence of a lower air chamber (11b), and an upper fluid chamber (11a), in that other suitable constructions may be provided for the injection device (1) where at least one interface (13) would provide a proper boundary between a given fluid flow (5) of thick fine tailings to be processed, and a neighboring or adjacent chamber of gas (3) to provide suitable fine bubbles of gas (3), such as compressed air (3a) for example, into the fluid flow (5), through the aforementioned at least one appropriate interface (13).

### Examples and Experimentation

Experiments were conducted to measure the effect of gas injection, more specifically compressed air, into an in-line fluid flow of MFT so as to reduce water content of the MFT. A specific dosage of polymer flocculant was added to the fluid flow to further assist dewatering at the polymer addition point. The polymer addition point may be the point at which polymer is added to the MFT. This point may be just before, during, or just after the injection of air into the fluid flow.

During each experiment, the controlled variable was compressed air at a given pressure (psi), which was introduced into the fluid flow. The polymer was also added to the fluid flow at a range of doses, measured in parts per million (ppm). For each dosage at the given air pressure, the net water release (NWR, in %) from the fluid flow (5) and the treated MFT (tMFT) yield stress (in Pa) were measured. Generally speaking, and for the purpose of the present specification, the “NWR” is a measure of the differential in water between the starting solids of the thick fine tailings and the solids of treated and drained thick fine tailings after a given draining time. The draining time may be 24 hours, 12 hours, or 20 minutes, for example, or another representative time period for drainage in the field. The NWR may be calculated as follows:

NWR=(Quantity of Water Recovered−Quantity of Flocculant Water Added)/(Quantity of Initial Thick Fine Tailings Water)

The water quantities are often measured on a volumetric basis. The water volume in the initial thick fine tailings may be determined using the Marcy Scale test, and the volume of water recovered may be determined by determining the solids content in the treated thick fine tailings obtained from a drying test. Other testing methods may be used, such as a rapid volumetric method which measures the volume of water released from a treated sample and determines the treated thick fine tailings solids from process data so more regular data may be obtained, e.g. on an hourly basis.

A NWR test may be conducted using immediate drainage of the treated thick fine tailings sample for a drainage time of about 20 minutes. In this regard, for optimal dosage range and good flocculation, the water release in 20 minutes may be about 80% of the water release that would occur over a 12 to 24 hour period. For underdosed or overdosed samples, the water release in 20 minutes may be about 20% to 60% of the water release that would occur over a 12 to 24 hour period. The 20 minute NWR test may therefore be followed by a longer NWR test, e.g. 12 hour drainage time, which may use a water volume or solids content measurement approach. It is also noted that the laboratory and field tests described herein used a volumetric 24 hour NWR test.

The use of “treated” in association with MFT is understood to mean MFT that has been subjected to air (3a) injection and polymer dosing (81), referred to herein as tMFT. The measured NWR and tMFT yield stress for each polymer dosage (81) at the given air pressure were compared against the comparison values, which are the NWR, polymer dosage (81), and tMFT yield stress when no air injection is performed and only a polymer dosage (81) is added. Visual observations were also made on the character of flocculation of MFT upon air addition.

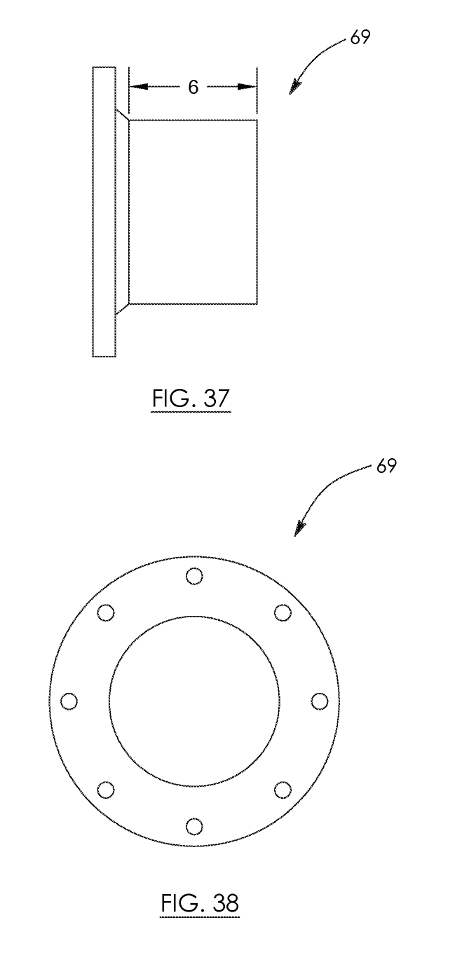

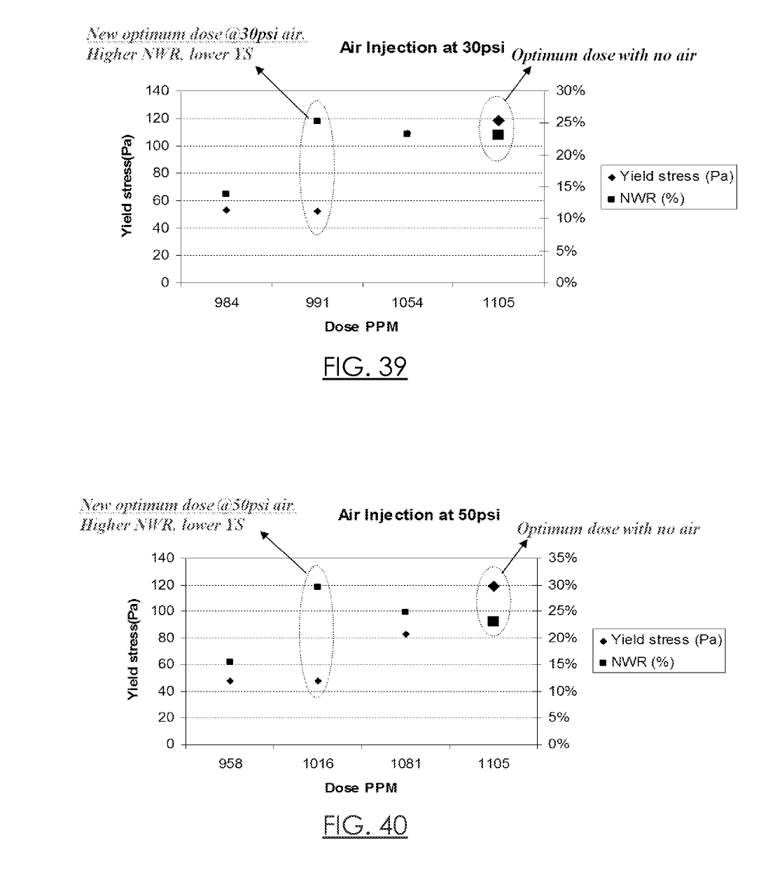

Results of injecting compressed air (3a) at 30 psi for various polymer dosages (81) are provided in FIG. 39. When no air (3a) was injected, the optimal polymer dosage (81) was about 1105 ppm, which provided a NWR of about 23% and a tMFT yield stress of about 120 Pa. FIG. 39 shows that at an air (3a) injection of 30 psi, a higher NWR was obtained at a lower dosage (81), and resulted in a lower tMFT yield stress. The optimum dosage (81) at 30 psi was about 991 ppm (which is about 114 ppm lower than the comparison value), and which provided a NWR of about 26% and a tMFT yield stress of about 53 Pa. Furthermore, no sputtering was observed at the discharge of air into the fluid flow (5), nor were any significant fluctuations observed. It was also visually observed that the flocculated tMFT was weaker in comparison to flocculated MFT observed when no air was injected.

The results of injecting compressed air (3a) at 50 psi for various polymer dosages (81) are provided in FIG. 40. When no air (3a) was injected, the optimal polymer dosage (81) and the resultant NWR and tMFT yield stress were the same as that described in relation to FIG. 39. FIG. 40 shows that at an air (3a) injection of 50 psi, a higher NWR was obtained at a lower dosage (81), and resulted in a lower tMFT yield stress. The optimum dosage (81) at 50 psi was about 1016 ppm (which is about 89 ppm lower than the comparison value), and which provides a NWR of about 30% and a tMFT yield stress of about 48 Pa. Furthermore, no sputtering was observed at the discharge, nor were any significant fluctuations observed. The flocculated tMFT was weaker in comparison to those observed when with no air was injected. The material observed was quite similar at all four discharge spigots.

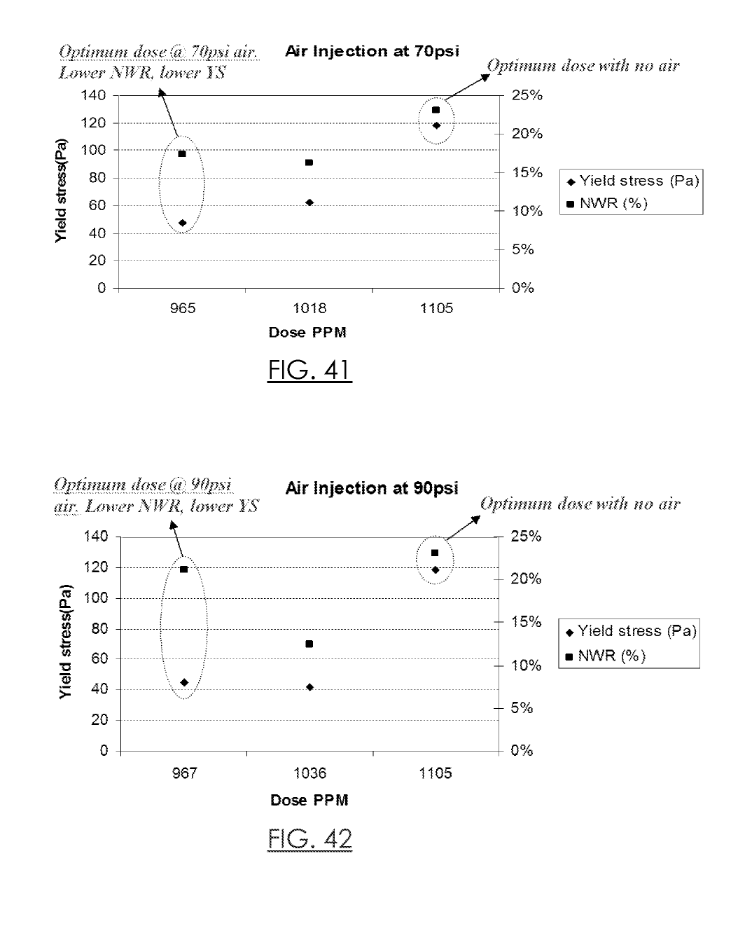

The results of injecting compressed air (3a) at 70 psi for various polymer dosages (81) are provided in FIG. 41. When no air (3a) was injected, the optimal polymer dosage (81) and the resultant NWR and tMFT yield stress were the same as that described in relation to FIG. 39. FIG. 41 shows that at an air (3a) injection of 70 psi, a lower NWR was obtained at a lower dosage (81), and resulted in a lower tMFT yield stress. Preliminary results indicate that at 70 psi, the potential difference in dosage (81) with the comparison value is about 140 ppm. At this dosage level, the highest NWR obtained was about 18% at a tMFT yield stress of about 48 Pa. The following visual observations were also made: the tMFT seemed quite over-sheared and “runny” with very little strength. Furthermore, no spluttering was observed, nor were any significant fluctuations observed.

The results of injecting compressed air (3a) at 90 psi for various polymer dosages (81) are provided in FIG. 42. When no air (3a) was injected, the optimal polymer dosage (81) and the resultant NWR and tMFT yield stress were the same as that described in relation to FIG. 39. FIG. 42 shows that at an air (3a) injection of 90 psi, a lower NWR was obtained at a lower dosage (81), and resulted in a lower tMFT yield stress. There was no determined optimum dosage (81), but preliminary results indicate that at 90 psi, the potential difference in dosage (81) with the comparison value is about 138 ppm. At this dosage level, the highest NWR obtained was about 23% at a tMFT yield stress of about 45 Pa. The following visual observations were also made: spluttering was observed at discharge and air pockets were visible. Air could be seen emerging from the spigots. The air pressure was deemed to be too high to be of much advantage because the tMFT was very runny with very little (and very weak) flocculation.

The results of these experiments are summarized in the following table:

TABLE 1
Preliminary Experimental Results

| Air | | | |
|---|---|---|---|
| pressure | Optimum NWR | New optimum NWR | Drop in dosage |
| (psi) | @ NO air | with air | (ppm) |
| 30 | 23.1% | 25.3% | 114 |
| 50 | 23.1% | 29.4% | 89 |
| 70 | 23.1% | 17.4% | 140 |
| 90 | 23.1% | 21.2% | 138 |

Results seem to indicate that increasing the pressure of air (3a) injected into the fluid flow (5) results in a greater NWR with a lower dosage (81), but only up to a threshold pressure of air. Past this threshold pressure, the NWR does not necessarily improve and other undesirable characteristics in the tMFT can be observed.

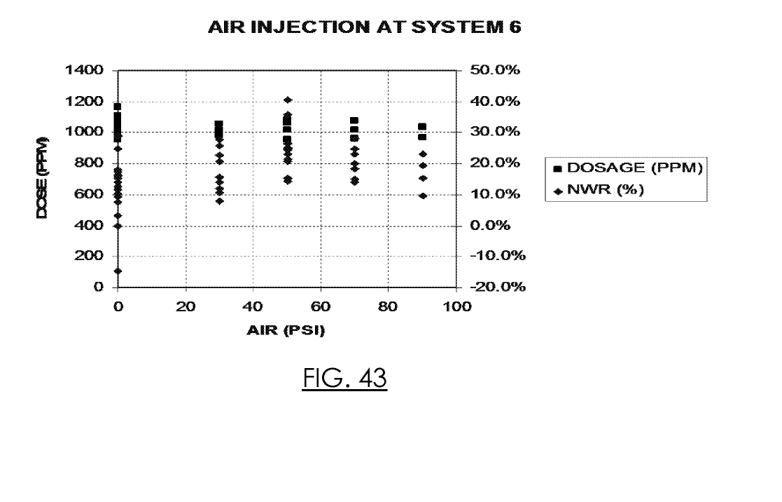

Indeed, as can be seen from FIG. 43, maximum NWR was obtained with 50 psi of air injected. It is therefore suspected that optimum water release could be obtained at much lower dosage (81) at this air pressure. Moreover, the highest dosage drop, of 114 ppm at optimum NWR, was obtained at 30 psi of air. At higher air pressures, such as at 70 psi and higher, the dosage drop was significant but there was a drop in NWR and the tMFT appeared very weak and runny. At 90 psi and higher, the tMFT was sputtering at discharge, and the formation of air pockets could be observed.

In light of the foregoing, it appears possible to obtain a reduction in the polymer dosage (81) used to facilitate water release by using air injection as described herein, and thus a reduction in polymer dosage (81) costs. Based on preliminary estimates, a drop in dosage (81) of 114 ppm or 140 ppm would result in polymer flocculant savings.

1. A process for dewatering thick fine tailings, comprising:
injecting a gas and adding a flocculant into a flow of thick fine tailings to produce a gas and flocculant treated flow comprising water and flocs; and
releasing the gas and flocculant treated flow at a drying site to allow water to separate and release from the flocs.

2. The process of claim 1, wherein the gas is injected in an amount sufficient to increase water released at the drying site.

3. The process of claim 1, wherein the gas is injected in an amount sufficient to reduce a quantity of the flocculant for obtaining the gas and flocculant treated flow.

4. The processes of claim 1, wherein the gas comprises air.

5. The process of claim 1, wherein
the gas is injected at a pressure between approximately 10 psi and 100 psi.

6. The process of claim 5, wherein the gas is injected at a pressure between approximately 30 psi and 90 psi.

7. The process of claim 5, wherein the gas is injected at a pressure below a pressure threshold so as to obtain increased water release compared to no air injection.

8. The process of claim 7, wherein the gas is injected at a pressure between 25 psi and 55 psi.

9. (canceled)

10. The process of claim 8, wherein the thick fine tailings has a line pressure between approximately 5 psi and 30 psi upon adding the flocculant.

11. The process of claim 1, wherein the flocculant is added as an aqueous solution comprising a dissolved flocculating agent.

12. The process of claim 1, wherein the flocculant is added into the thick fine tailings before the gas is injected.

13. The process of claim 1, wherein the flocculant is added into the thick fine tailings while the gas is being injected.

14. The process of claim 1, wherein the flocculant is added into the thick fine tailings after the gas has been injected.

15. The process of claim 1, wherein the flocculant comprises a high molecular weight anionic polymer flocculant.

16. The process of claim 15, wherein the polymer flocculant is added into the thick fine tailings at a dosage between approximately 500 and 1500 ppm on a clay basis.

17. The process of claim 16, wherein the dosage is between approximately 600 and 2200 ppm on a total solids basis.

18. The process of claim 1, further comprising screening the thick fine tailings prior to injecting the gas and adding the flocculant, to remove coarse debris therefrom.

19. The process of claim 1, wherein the thick fine tailings comprise oil sands thick fine tailings.

20. The process of claim 1, wherein the thick fine tailings are retrieved from a pond as mature fine tailings.

21. A system for dewatering thick fine tailings, comprising:
a fluid transportation assembly for providing a thick fine tailings fluid flow;
a gas injection device for injecting a gas into the fluid flow to produce a gas-treated fluid;
a mixer for mixing a flocculant into the fluid flow; and
a drying site for receiving a gas and flocculant treated mixture comprising water and flocs, the drying site allowing water to separate from the flocs and/or evaporate.

22-29. (canceled)

30. The system of claim 21, wherein the mixer is configured for mixing the flocculant into the fluid flow while the gas injection device is injecting the gas.

31-37. (canceled)

38. A gas injection device for treating thick fine tailings, comprising:
an inlet for receiving the thick fine tailings;
an outlet for releasing gas-treated tailings; and
a gas injector disposed between the inlet and the outlet, the gas injector configured to inject gas into the thick fine tailings to produce a gas-treated tailings sufficient to facilitate flocculation and dewatering of the thick fine tailings.

39. The device of claim 38, wherein the gas injector comprises a transitional housing disposed between the inlet and the outlet, the transitional housing including at least one interface separating the transitional housing between a first chamber where the thick fine tailings entering the inlet is allowed to travel before exiting from the outlet, and a second chamber where the gas therein is pressurized, the at least one interface being configured for allowing the gas from the second chamber to be introduced into the thick fine tailings in the first chamber.

40. The device of claim 39, wherein the transitional housing comprises an inlet having a substantially circular cross-section, and a main section having a substantially rectangular cross-section.

41-42. (canceled)

43. The device of claim 39, wherein
the transitional housing comprises a side nozzle plate, provided with a nozzle for receiving the gas from a source of pressurized gas.

44. The device of claim 43, wherein the nozzle is provided on a side nozzle cover being removably mountable onto a corresponding opening of the side nozzle plate.

45. (canceled)

46. The device of claim 45, wherein the transitional housing comprises an interface plate configured for receiving the at least one interface.

47-59. (canceled)

60. The device of claim 39, wherein the at least one interface comprises at least one diffuser plate.

61. The device of claim 60, wherein the at least one diffuser plate is composed of ceramic.

62-63. (canceled)

64. The device of claim 38, wherein
the inlet or the outlet is in fluid communication with a mixer for mixing a flocculant into the thick fine tailings.

65. The device of claim 64, wherein the inlet is in fluid communication with the mixer.

66. The device of claim 38, wherein
the gas injector is configured in sufficient proximity with a mixer for mixing a flocculant into the thick fine tailings such that the gas and the flocculant are simultaneously injected into the thick fine tailings.

67-68. (canceled)

69. The device of claim 38, wherein the gas injector is peripherally mounted about a flow of the thick fine tailings so as to introduce the gas therein.

70. The device of claim 69, wherein the inlet receives the thick fine tailings via a cylindrical inlet pipe, and the outlet releases the gas-treated thick fine tailings via a cylindrical outlet pipe.

71. The device of claim 70, wherein the gas injector is annular and mounted substantially co-axially with the cylindrical inlet pipe and the cylindrical outlet pipe so as to introduce the gas into the flow of the thick fine tailings along a plurality of radial trajectories.

72. The device of claim 71, wherein the gas injector comprises a circular flange.

73. The device of claim 73, wherein the circular flange comprises a rim defining a circular passage having an internal diameter allowing the flow of the thick fine tailings to pass therethrough.

74. The device of claim 72, wherein the circular flange further comprises:
a distribution chamber configured circumferentially within the rim for receiving the gas to be introduced into the thick fine tailings; and
orifices positioned circumferentially around the rim and being in fluid communication with the distribution chamber for receiving the gas and introducing the gas into the flow of the thick fine tailings.

75. The device of claim 74, wherein the orifices are configured so as to be inwardly facing and arranged at regular interval locations around the rim, so as to inject the gas toward a center of the flow of the thick fine tailings.

76. The device of claim 75, wherein each interval location includes at least two of the orifices that are oriented so as to tapper inwardly toward each other as the at least two orifices extend from the distribution chamber toward the flow of the thick fine tailings.

77. The device of claim 38, wherein the thick fine tailings comprise oil sands thick fine tailings.

78. The device of claim 38, wherein the gas injector includes gas injection orifices sized below about 1.5 millimeters.

79. The device of claim 78, wherein the gas injection orifices are sized between about 1 millimeter and about 1.5 millimeters.

80. A method of reducing flocculant dosage for flocculating thick fine tailings comprising injecting an effective amount of gas into the thick fine tailings.

81-84. (canceled)

85. A method of increasing water release from flocculated thick fine tailings obtained by flocculant addition to thick fine tailings, comprising injecting an amount of gas effective to increase water release into the thick fine tailings and/or the flocculated thick fine tailings.

86-90. (canceled)
